(19) United States
(12) Patent Application Publication
(10) Pub. No.: US 2015/0056839 A1
(43) Pub. Date: Feb. 26, 2015

(54) ELECTRICAL CONNECTOR WITH POWER TERMINALS

(71) Applicant: Xuehai Zhang, Xuzhou (CN)

(72) Inventor: Xuehai Zhang, Xuzhou (CN)

(73) Assignee: Molex Incorporated, Lisle, IL (US)

(21) Appl. No.: 14/237,305

(22) PCT Filed: Aug. 3, 2012
(86) PCT No.: PCT/CN2012/001042

§ 371 Date: May 22, 2014

(30) Foreign Application Priority Data
Aug. 5, 2011 (CN) 201120291630.0
Aug. 2, 2012 (CN) 201220378234.6
Aug. 2, 2012 (CN) 201220378258.1
Aug. 2, 2012 (CN) 201220378302.9
Aug. 2, 2012 (CN) 201220378302.X
Aug. 2, 2012 (CN) 201220378325.X
Aug. 2, 2012 (CN) 201220378383.2

(51) Int. Cl. H01R 13/646; H01R 13/627; H01R 24/68

(52) U.S. Cl. CPC H01R 13/646; H01R 24/68; H01R 13/6271
USPC 439/350; 439/607.55

(57) ABSTRACT

An electrical connector assembly comprises a receptacle electrical connector and a plug electrical connector. The receptacle electrical connector includes a first body having a first and a second tongues and a plurality of first terminals, the first terminals located on opposite surfaces of the first tongue and offset relative to each other. The plug electrical connector includes a second body and a third and fourth mating chambers located in the second body; a plurality of third terminals, wherein the third terminals located on upper and lower sides of the third mating chamber are offset relative to each other. The receptacle electrical connector and the plug electrical connector can mate with each other so the first terminals and the third terminals are mated with each other to transmit signals and the second tongue and the fourth mating chamber are connected to transmit power.

### RELATED APPLICATIONS

This application is a national phase of PCT Application No. PCT/CN2012/001042, filed Aug. 3, 2012, which in turn claims priority to the following applications: Chinese Application No. 201120291630.0, filed Aug. 5, 2011; Chinese Application No. 201220378234.6, filed Aug. 2, 2012; Chinese Application No. 201220378258.1, filed Aug. 2, 2012; Chinese Application No. 201220378276.X, filed Aug. 2, 2012; Chinese Application No. 201220378302.9, filed Aug. 2, 2012; Chinese Application No. 201220378325.X, filed Aug. 2, 2012; and Chinese Application No. 201220378383.2, filed Aug. 2, 2012, all of which are incorporated herein by reference in their entirety.

### FIELD OF THE INVENTION

The present invention relates to an electrical connector, and more particularly, to a receptacle electrical connector, a plug electrical connector and an electrical connector assembly having an improved structure for transmitting signals and power.

### BACKGROUND OF THE INVENTION

Conventional electrical connector assembly comprises a receptacle electrical connector and a corresponding plug electrical connector, through which a signal cable connector can be combined with a power cable connector, such that an electrical connection for transmitting both video signal and power between a video source device (such as computer, DVD, Video Game) and a display device (such as a display, TV, projector) can be achieved through one cable.

Chinese Patent ZL 200920002141.1 discloses a plug electrical connector, a receptacle electrical connector and an electrical connector assembly. The plug electrical connector comprises a first insulated housing having a first main body and a first protrusion extending upward from an upper surface of the first main body, the first main body having an upper tongue and a lower tongue which are provided with a plurality of first terminal slots, the first protrusion being provided with two second terminal slots; a plurality of first terminals, each of which is provided in the first terminal slot respectively, and has a guiding portion protruding out of a rear wall of the first main body; two second terminals, each of which is provided in the second terminal slot respectively, and has an inserting portion protruding out of a front wall of the first protrusion and a guiding portion protruding out of a rear wall of the first protrusion; and a first metal element enclosing the first insulated housing and having a first mating opening at a side adjacent to the inserting portions of the two second terminals. The receptacle electrical connector comprises a second insulated housing having a second main body, a second protrusion extending upward from an upper surface of the second main body, a third tongue extending forward from the second main body, an extension portion extending forward from the second protrusion and spaced from the third tongue, a plurality of third terminal slots being provided in an upper and a lower side of the third tongue respectively and two fourth terminal slots running through the second protrusion and the extension portion; a plurality of third terminals, each of which is provided in the third terminal slot, and has a contacting portion in a side of the third tongue; two fourth terminals, each of which is provided in the fourth terminal slots respectively, and has a contacting portion; and a second metal element enclosing the second insulated housing and having a second mating opening at a side adjacent to the third tongue. The electrical connector assembly comprises the above receptacle electrical connector and the above plug electrical connector, the receptacle electrical connector can be mated with the plug electrical connector via the first and second mating openings, the first terminals and the third terminals are electrically connected with each other, the two second terminals and the two fourth terminals are electrically connected with each other, such that both the video signals and the power are transmitted simultaneously. Thereby, cables can be handled easily and a space can be saved.

However, the inserting portion of the second terminals for transmitting the power in the conventional plug electrical connector is exposed and extending straightforward without any protection. So, the inserting portion of the second terminals in the plug electrical connector is easily failed due to the bending caused by the extension portion of the receptacle electrical connector when mis-plugging, during mating with the conventional receptacle electrical connector. Thus, the reliability of electrically connection between the video source device and the display device is lowered. In addition, the fourth terminals in the receptacle electrical connector mated with the second terminals of the plug electrical connector are two contacting portions formed by fixing arms having an invert U shape and extending opposite. Thus, the structures of contacting portions of the fourth terminals are too complex to manufactured, and occupy a relative larger space and fail to have a compact design. Furthermore, the contacting portions of the third terminals on the upper and lower sides of the third tongue in the conventional receptacle connector are aligned up and down relative to each other, such that the two contacting portions in the upper and lower side are arranged face to face. Therefore, the arranging manner of the above contacting portions tends to produce signal noise and is not propitious to improve the transmitting quality of signals.

Therefore, it is necessary to further improve the conventional electrical connector so as to satisfy the requirements of the current products.

### SUMMARY OF THE INVENTION

There is provided a receptacle electrical connector with a first body, comprising a first main body portion, a first tongue and a second tongue being parallel with each other and extending forward from the first main body portion, wherein the first tongue has a width greater than that of the second tongue, a plurality of first receiving slots are provided on opposite first and second surfaces of the first tongue, at least two second receiving slots are provided on a surface of the second tongue and a plurality of first terminals for transmitting signal, provided in the first receiving slots respectively, each first terminals being provided with a mating portion in a plate shape and a soldering portion, and the mating portions of the first terminals located on a first surface are offset relative to those on a second surface of the first tongue; at least two second terminals for transmitting power, provided in the at least two second receiving slots respectively, each second terminals being provided with a mating portion in a plate shape and a soldering portion; and a first cage mounted on the first body; wherein a first mating chamber, which is formed around and enclosing the first tongue, has a width larger than that of a second mating chamber which is formed around and enclosing the second tongue, a receiving chamber is formed by stacking the first and second mating chambers communicated with each other.

In an embodiment, a plug electrical connector includes a second body having a second main body portion and a second protrusion protruding upward from a top surface of the second main body portion, middle of the second main body portion is provided with a third mating chamber, a plurality of third receiving slots are provided on upper and lower sides of third mating chamber, two fourth receiving slots are provided on the second protrusion and a plurality of third terminals are provided in the plurality of third receiving slots respectively, each of the third terminals comprises a mating portion being an elastic protrusion and a soldering portion, and the mating portions of the third terminals located on the upper side of the third mating chamber are offset relative to those located on the lower side of the third mating chamber and two fourth terminals for transmitting power are provided in the two fourth receiving slots respectively, each of the fourth terminals comprises a mating portion being an elastic protrusion and a soldering portion; and a second cageenclosing a periphery of the second body, a fourth mating chamber is formed by the second cage enclosing the second protrusion, the mating portion of the fourth terminals protrudes from the fourth receiving slots towards the fourth mating chamber.

Another embodiment provides an electrical connector assembly with a receptacle electrical connector, comprising a first body, comprising a first main body portion, a first tongue and a second tongue being parallel with each other and extending forward from the first main body portion, wherein the first tongue has a width greater than that of the second tongue, a plurality of first receiving slots are provided on opposite first and second surfaces of the first tongue, at least two second receiving slots are provided on a surface of the second tongue and a plurality of first terminals for transmitting signal provided in the first receiving slots respectively, each first terminals being provided with a mating portion in a plate shape and a soldering portion, and the mating portions of the first terminals located on a first surface are offset relative to those on a second surface of the first tongue and at least two second terminals for transmitting power are provided in the second receiving slots respectively, each second terminals being provided with a mating portion in a plate shape and a soldering portion; and a first cage mounted on the first body that defines a first mating chamber which is formed around and enclosing the first tongue, has a width larger than that of a second mating chamber which is formed around and enclosing the second tongue, a receiving chamber is formed by stacking the first and second mating chambers communicated with each other; and

The electrical connector assembly includes a plug electrical connector that can include a second body having a second main body portion, middle of the second main body portion is provided with a third mating chamber, and a plurality of third receiving slots are provided on upper and lower sides of the third mating chamber are provided with a plurality of third terminals provided in the plurality of third receiving slots respectively, each of the third terminals comprises a mating portion being an elastic protrusion and a soldering portion, and the mating portions of the third terminals located on the upper side of the third mating chamber are offset relative to those located on the lower side of the third mating chamber and a second cage enclosing a periphery of the second body and the first tongue of the receptacle electrical connector is mated with the third mating chamber of the plug electrical connector, so that the plurality of first terminals are electrically connected with the plurality of third terminals to transmit video signals.

### BRIEF DESCRIPTION OF THE DRAWINGS

FIG. 1 is a perspective view showing a first embodiment of an electrical connector assembly and a circuit board, and wherein, a cable connector with a plug electrical connector and a receptacle electrical connector in the circuit board are in a state of mating with each other;

FIG. 2 is a perspective view showing a first embodiment of an electrical connector assembly and a circuit board, and wherein, a first cable connector with a plug electrical connector and a receptacle electrical connector in the circuit board are in a state of separated with each other in a first view angle;

FIG. 3 is another perspective view showing a first embodiment of an electrical connector assembly and a circuit board, and wherein, a first cable connector with a plug electrical connector and a receptacle electrical connector in the circuit board are in a state of separated with each other in a second view angle;

FIG. 4 is an exploded perspective view showing a first embodiment of a receptacle electrical connector and a circuit board;

FIG. 5 is a front view showing a first embodiment of a receptacle electrical connector;

FIG. 6 is a rear view showing a first embodiment of a receptacle electrical connector;

FIG. 7 is a sectional view in a B-B direction in FIG. 6;

FIG. 8 is a perspective view showing a first embodiment of a receptacle electrical connector;

FIG. 9 is an exploded perspective view showing a first embodiment of a receptacle electrical connector;

FIG. 10 is a further exploded perspective view showing a first embodiment of a receptacle electrical connector in a first view angle;

FIG. 11 is a further exploded perspective view showing a first embodiment of a receptacle electrical connector in a second view angle;

FIG. 12 is another exploded perspective view showing a first embodiment of a receptacle electrical connector in a second view;

FIG. 13 is an exploded perspective view showing a first embodiment of a plug electrical connector and an insulated outer housing, a metal inner housing and a cable;

FIG. 14 is a further exploded perspective view of FIG. 13;

FIG. 15 is a front view showing a first embodiment of a plug electrical connector;

FIG. 16 is a sectional view in an A-A direction in FIG. 15;

FIG. 17 is a perspective view of a first embodiment of a plug electrical connector;

FIG. 18 is an exploded perspective view of a first embodiment of a plug electrical connector;

FIG. 19 is a further exploded perspective view of a first embodiment of a plug electrical connector;

FIG. 20 is a perspective view showing a second embodiment of a receptacle electrical connector and a sealed cap fitted with each other;

FIG. 21 is an exploded perspective view showing a second embodiment of a receptacle electrical connector and a sealed cap;

FIG. 22 is a front view of a second embodiment of a receptacle electrical connector;

FIG. 23 is a sectional view in an A-A direction in FIG. 22;

FIG. 24 is an exploded perspective view showing a second embodiment of a receptacle electrical connector;

FIG. 25 is exploded perspective view of the embodiment depicted in FIG. 24;

FIG. 26 is another exploded perspective view of the embodiment depicted in FIG. 24

FIG. 27 is a perspective view of a third embodiment of a receptacle electrical connector;

FIG. 28 is a front view of a third embodiment of a receptacle electrical connector;

FIG. 29 is an exploded perspective view of a third embodiment of a receptacle electrical connector;

FIG. 30 is a further exploded perspective view of a third embodiment of a receptacle electrical connector;

FIG. 31 is another exploded perspective view of a third embodiment of a receptacle electrical connector;

FIG. 32 is a front view of a fourth embodiment of a receptacle electrical connector;

FIG. 33 is exploded perspective view of a fourth embodiment of a receptacle electrical connector;

FIG. 34 is an exploded perspective views of a fourth embodiment of a receptacle electrical connector;

FIG. 35 is a side view showing a combination of a first body and terminals in a fourth embodiment of a receptacle electrical connector;

FIG. 36 is a sectional view in an A-A direction in FIG. 35;

FIG. 37 is a further exploded perspective view of a fourth embodiment of a receptacle electrical connector;

FIG. 38 is a further exploded perspective view on the basis of FIG. 37;

FIG. 39 is a perspective view of a fifth embodiment of a receptacle electrical connector;

FIG. 40 is a front view of a fifth embodiment of a receptacle electrical connector;

FIG. 41 is a section view in an A-A direction in FIG. 40;

FIG. 42 is an exploded perspective view of a fifth embodiment of a receptacle electrical connector;

FIG. 43 is a further exploded perspective view on the basis of FIG. 42;

FIG. 44 is an exploded perspective view of a fifth embodiment of a receptacle electrical connector after removing a cage;

FIG. 45 is a further exploded perspective view on the basis of FIG. 44;

FIG. 46 is a perspective view of a sixth embodiment of a receptacle electrical connector;

FIG. 47 is a perspective view of a sixth embodiment of a receptacle electrical connector in another view angle;

FIG. 48 is a front view of a sixth embodiment of a receptacle electrical connector;

FIG. 49 is a sectional view in an A-A direction in FIG. 3;

FIG. 50 is an exploded perspective view of a sixth embodiment of a receptacle electrical connector;

FIG. 51 is a further exploded perspective view of a sixth embodiment of a receptacle electrical connector, and wherein a first cage is omitted;

FIG. 52 is a perspective view showing a sixth embodiment of a receptacle electrical connector mating with a first cable connector, and wherein a plug electrical connector in accordance with a first embodiment is provided in a front of the first cable connector;

FIG. 53 is a perspective view showing a sixth embodiment of a receptacle electrical connector mating with a second cable connector, and wherein a plug electrical connector in accordance with a second embodiment is provided in a front of the second cable connector;

FIG. 54 is a perspective view of a second cable connector shown in FIG. 53;

FIG. 55 is a front view of a second cable connector shown in FIG. 54;

FIG. 56 is an exploded perspective view showing a sixth embodiment of a receptacle electrical connector and a second cable connector;

FIG. 57 is a sectional view in a Z-Z direction in FIG. 56;

FIG. 58 is a perspective view of a seventh embodiment of a receptacle electrical connector;

FIG. 59 is a front view of a seventh embodiment of a receptacle electrical connector;

FIG. 60 is a sectional view in an A-A direction in FIG. 59;

FIG. 61 is an exploded perspective view of a seventh embodiment of a receptacle electrical connector;

FIG. 62 is a further exploded perspective view of a seventh embodiment of a receptacle electrical connector;

FIG. 63 is a perspective view of an eighth embodiment of a receptacle electrical connector;

FIG. 64 is a front view of an eighth embodiment of a receptacle electrical connector;

FIG. 65 is a sectional view in a B-B direction in FIG. 64;

FIG. 66 is a perspective view of a third cable connector adapted to mate with a third receiving slot in an eighth embodiment of a receptacle electrical connector, and wherein, a plug electrical connector in accordance with a third embodiment is provided in a front of the third cable connector;

FIG. 67 is a front view of a cable connector shown in FIG. 66;

FIG. 68 is a sectional view in a C-C direction in FIG. 67;

FIG. 69 is a perspective view of a ninth embodiment of a receptacle electrical connector;

FIG. 70 is a front view of a ninth embodiment of a receptacle electrical connector;

FIG. 71 is an exploded perspective view of a ninth embodiment of a receptacle electrical connector; and

FIG. 72 is a further exploded perspective view of a ninth embodiment of a receptacle electrical connector;

### DETAILED DESCRIPTION OF THE PREFERRED EMBODIMENTS

While the present invention may be susceptible to in different forms of embodiment, there is shown in the Figures, and will be described herein in detail, specific embodiments, with the understanding that the disclosure is to be considered an exemplification of the principles of the Present Application, and is not intended to limit the present invention to that as illustrated.

One technical problem that can addressed by the present disclosure is to provide a plug electrical connector, a receptacle electrical connector and an electrical connector assembly having an improved structure for transmitting signals and power, such that the signals transmitting quality between the video source device and the display device can be improved and a compact design propitious to manufacture can be achieved. Compared to the prior art, the plug electrical connector, the receptacle connector and the electrical connector assembly in may have several advantageous benefits.

The mating portions of the fourth terminals in the plug electrical connector are configured to have an elastic protrusion shape, and partly received in the fourth receiving slots of the second protrusion so as to protrude upward, such that the mating portions of the fourth terminals can be protected by the second protrusion. Therefore, the mating portions of the fourth terminals in the plug electrical connector are not easily to be bent and failed during mating with the receptacle electrical connector.

The mating portions of the second terminals in the receptacle electrical connector are configured to have a flat shape, and partly received in the second receiving slots of the surface of the second tongue, such that the mating portions of the second terminals have a relative simply structure so as to easily manufacture and have a compact design.

The mating portions of upper row of the first terminals in the receptacle electrical connector are offset relative to those of lower row of the first terminals, and the mating portions of upper row of the third terminals in the plug electrical connector are also offset relative to those of lower row of the third terminals, such that the signal noises can be reduced and the signal transmitting quality between the video source device and the display device can be improved.

In the embodiments illustrated in the Figures, representations of directions such as up, down, left, right, front and rear, used for explaining the structure and movement of the various elements of the Present Application, are not absolute, but relative. These representations are appropriate when the elements are in the position shown in the Figures. If the description of the position of the elements changes, however, these representations are to be changed accordingly.

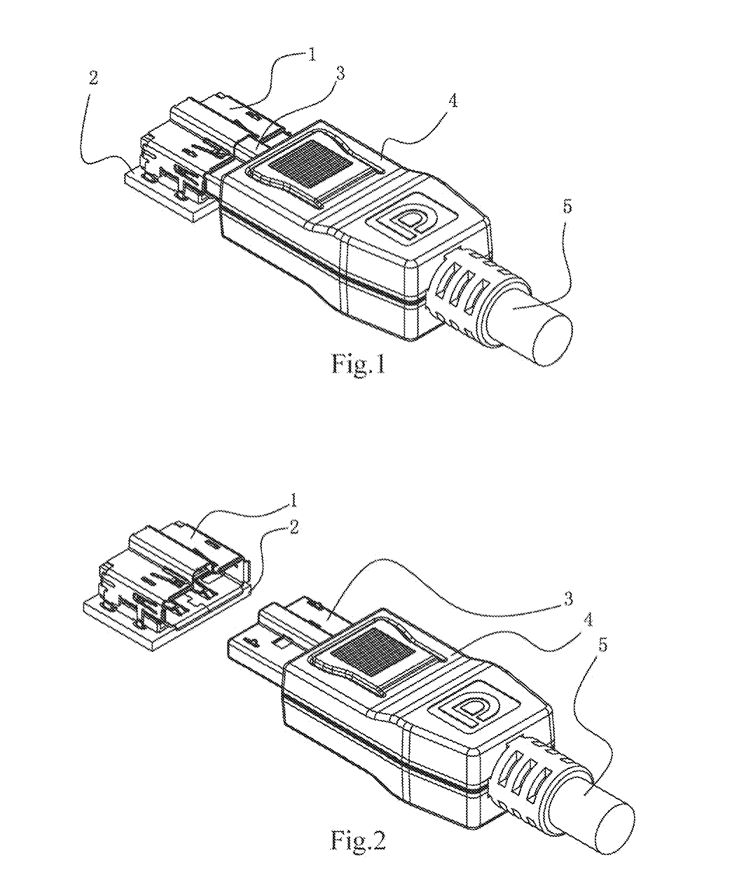

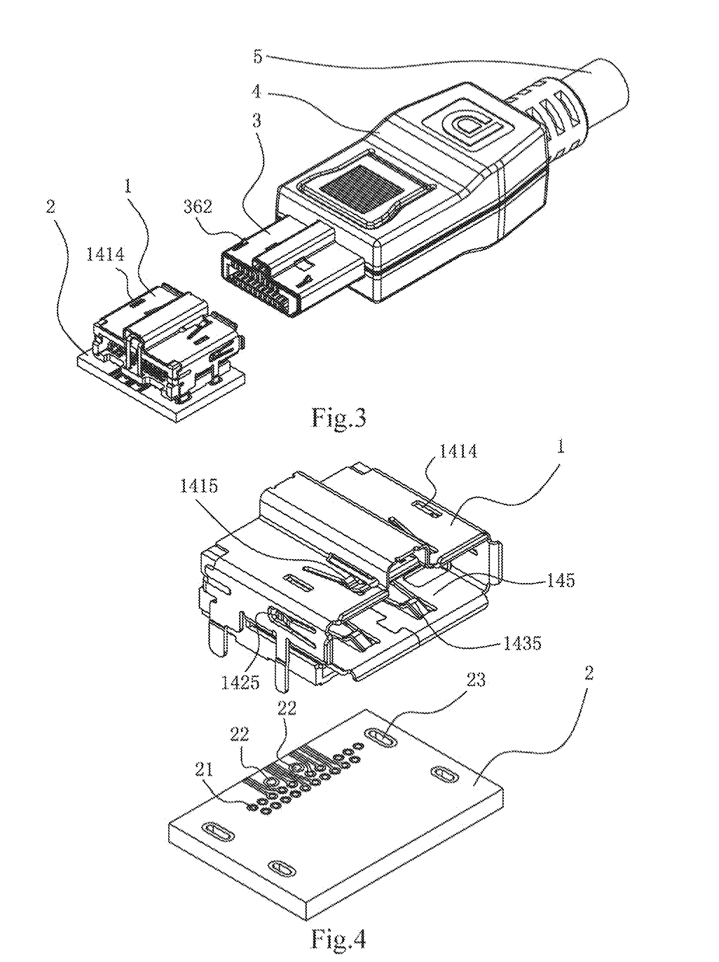

As shown in FIGS. 1-4, the electrical connector assembly in accordance with a first embodiment of the present disclosure comprises a receptacle electrical connector 1 and a plug electrical connector 3 mated with each other. The receptacle electrical connector 1 can be soldered to a circuit board 2 of a video source device (not shown) or a display device (not shown), the plug electrical connector 3 can be combined with an outer housing 4, which can be formed of an insulative material, and a cable 5 so as to form a first cable connector. The receptacle electrical connector 1 and the plug electrical connector 3 are mated with each other, such that the video signal and power can be transmitted between the video source device and the display device.

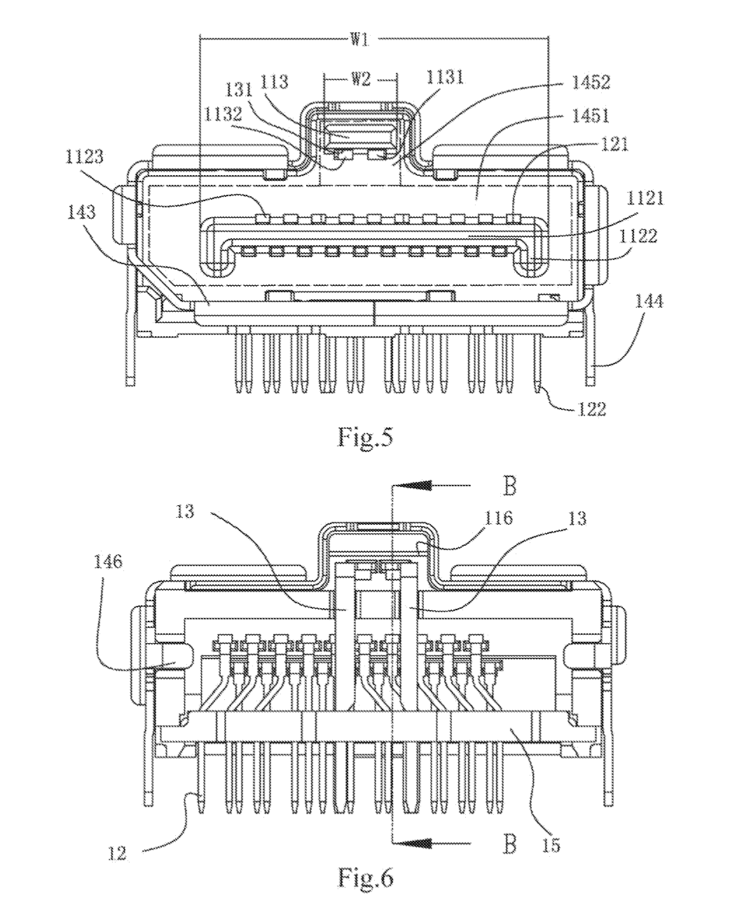

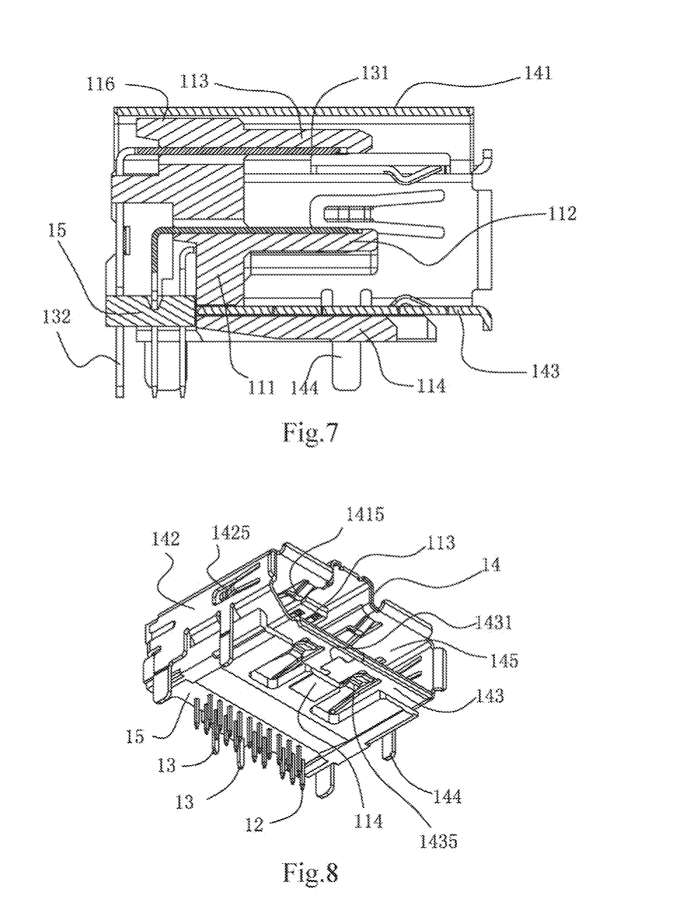

As shown in FIGS. 5-12, which depict a first embodiment, the receptacle electrical connector 1 comprises a first body 11, which can be formed of an insulative material; a plurality of first terminals 12 and two second terminals 13 mounted on the first body 11; a first cage 14 mounted on an outside of the first body 11 and a first retention element 15 mounted on a rear end of the first body 11.

The first body 11 comprises a first main body portion 111, a first tongue 112 and a second tongue 113 extending forward from the first main body 111. The first main body portion 111 has a first protrusion 116 protruding upward and having a relative narrow width. The first tongue 112 extends forward from a middle of the first main body portion 111, and the second tongue 113 extends forward from the first protrusion 116. The first body 11 further comprises a bottom plate 114 extending forward from a bottom of the first main body portion 111, and a retention plate fixing portion 115 provided on a rear end of the bottom of the first main body portion 111.

Referring to FIG. 5, the first tongue 112 comprises a base 1121 in a plate shape and two keying ribs 1122 protruding downward from a left and right side edge of the base 1121 respectively. A plurality of first receiving slots 1123 are provided on opposite upper and lower surfaces (opposite first and second surfaces) of the base 1121. The first tongue 112 can be mated with a standard DP (Display Port) type plug electrical connector. The two keying ribs 1122 of the first tongue 112 can prevent the other different type plugs from being wrongly inserted into the receptacle electrical connector 1, so as to prevent the first cage 14 from breaking

The first and second tongue 112 and 113 are configured to be parallel with each other and arranged in an upper and lower relationship. The first tongue 112 has a width W1 larger than that W2 of the second tongue 113, such that the mating plug electrical connector 3 can be effectively prevented from being mistakenly inserted onto the receptacle electrical connector 1.

Referring to FIG. 12, two second receiving slots 1131, 1132 are provided on the lower surface of the second tongue 113. A front end of the second receiving slot 1131 is located at a position forward of the second receiving slot 1132.

The first terminals 12 can be divided into upper and lower rows. Each of the first terminals 12 has a mating portion 121 in a plate shape, a soldering portion 122 and a fixing portion 123 connected between the mating portion 121 and the soldering portion 122. The mating portions 121 of the first terminals 12 are provided in first receiving slots 1123 located on upper and lower surfaces of the base 1121 of the first tongue 112, for transmitting high definition video signals. Also referring to FIG. 5, the mating portions 121 of the first terminals 12 located on the upper surface of the first tongue 112 are offset relative to those on the lower surface of the first tongue 112, that is, the mating portions 121 are not faced or aligned with each other in an upper and lower direction, such that the distance between the mating portions 121 of the upper row of first terminals and those of the lower row of first terminals can be increased, thusly reducing the signal noises during the high frequency data transmission and improving the signals transmitting quality.

Each of the second terminals 13 comprises a mating portion 131 in a plate shape, a soldering portion 132 and a fixing portion 133 connected between the mating portion 131 and the soldering portion 132. One second terminals 13 received in the corresponding second receiving slot 1131 is used to connect with the negative pole of the power source, and the other received in the corresponding second receiving slot 1132 is used to connect with the positive pole of the power source. A distal 1311 of the mating portion 131 of the one second terminals 13 connected to the negative pole of the power source is located on a position closer to the front than a distal 1312 of the mating portion 131 of the other second terminals 13 connected to the positive pole of the power source. The two second terminals 13 are used to transmit the power required by the display device, so as to save one separate power cable of the display device. In addition, as shown in FIGS. 6 and 12, the two soldering portions 132 of the two second terminals 13 bend and extend away from each other, such that a first distance between the two soldering portions 132 is larger than a second distance between the two mating portions 131 of the two second terminals 13.

Referring to FIGS. 9-11, the first cage 14 is formed by punching a metal plate and has a shape with a small upper portion and a larger lower portion. The first cage 14 comprises a top plate 141, two side plates 142 bending and extending downward from left and right sides of the top plate 141, a bottom plate 143 formed by horizontally bending and extending the two side plates 142 toward each other and finally engaging with each other, and four fixing foots 144 extending downward from the side plates 142. An arching portion 1411 in an invert U shape extends upward from a middle of the top plate 141.

Referring to FIG. 5, the first cage 14 encloses the first and second tongue 112 and 113, such that a receiving chamber 145 in a shape of small upper portion and large lower portion is formed. The receiving chamber 145 comprises a first mating chamber 1451 and a second mating chamber 1452 (as shown by the dotted-line in FIG. 5) stacked in an up and down direction and communicated with each other. The first tongue 112 is received in the first mating chamber 1451 in which a standard DP plug can be inserted. The second tongue 113 is received in the second mating chamber 1452 which is located above the first mating chamber 1451 and has a much narrower width than that of the first mating chamber 1451. An engaging line 1431 extending in a front to rear direction is formed on the bottom of the first cage 14. The bottom plate 114 of the first body 11 supports the first cage 14 from below the engaging line 1431 of the first cage 14, so as to prevent the engaging line 1431 the first cage 14 from breaking and widening due to the distortion after using the receptacle connector for a long term.

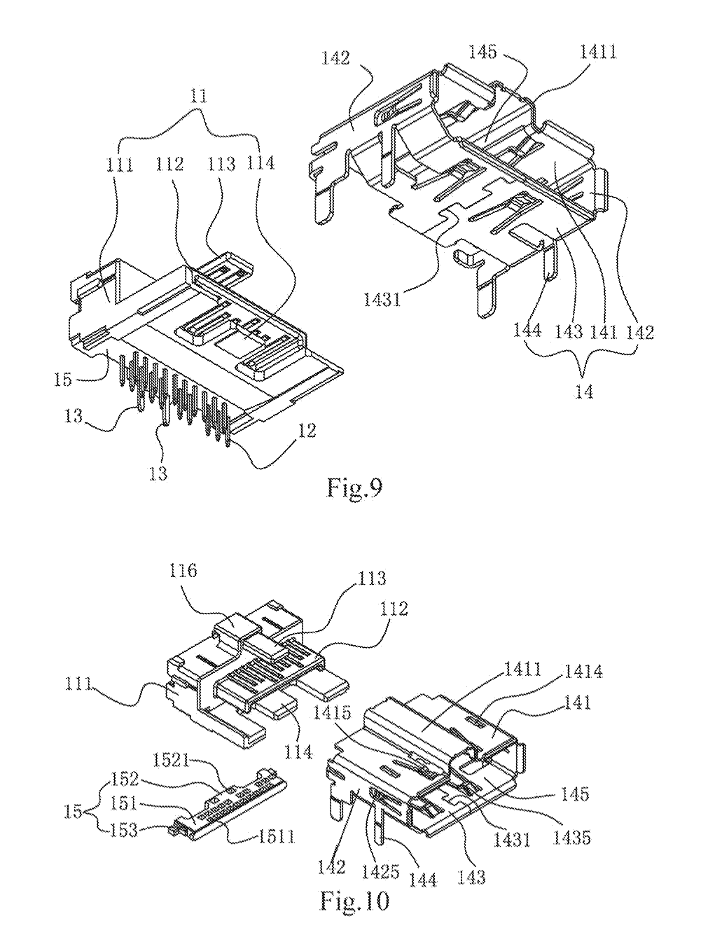

Referring to FIG. 10, the first cage 14 is provided with a hole 1414 on each of the left and right sides of the arching portion 1411. The top plate 141 is provided with a flexible clasp arm 1415 extending from rear to front on each of the left and right sides of the arching portion 1411. The bottom plate 143 is provided with a flexible clasp arm 1435 extending from rear to front on each of the left and right sides thereof. Each of the two side plates 142 is provided with a flexible clasp arm 1425 extending from front to rear. Those flexible clasp arms 1414, 1425, 1435 can be clasped on the different sides and positions in different depths of the plug electrical connector 3, to improve the engaging strength.

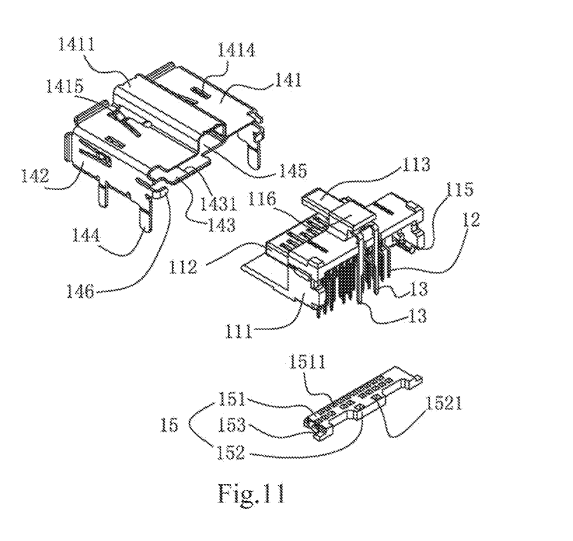

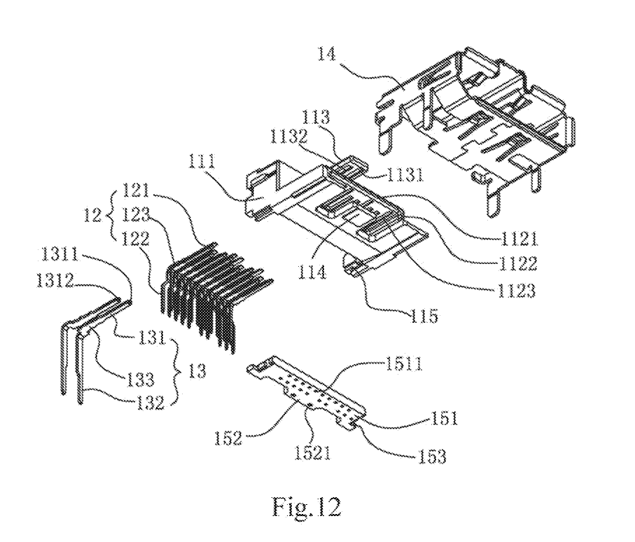

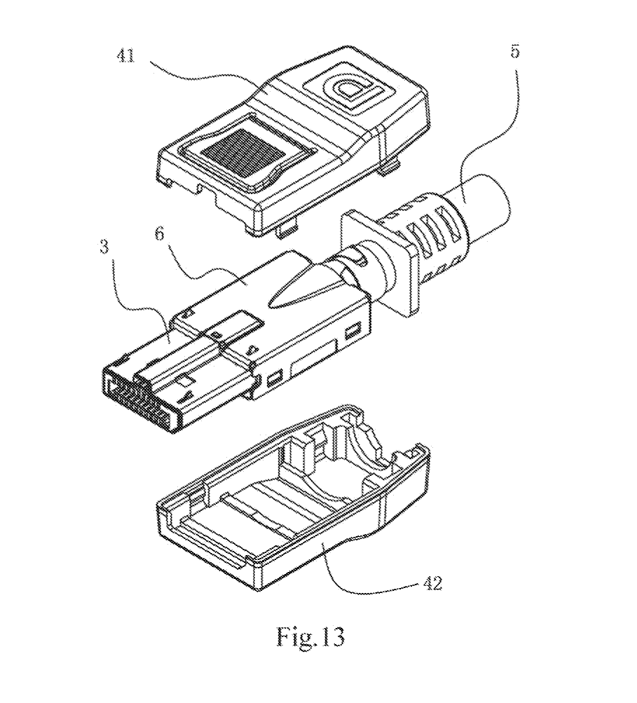

Referring to FIGS. 10 and 11, the first retention element 15 comprises a base 151 in a plate shape, a protrusion 152 protruding backward from a middle of rear end of the base 151, and two body fixing portions 153f provided on two sides of the base 151. The base 151 is provided with a plurality of perforations 1511 communicated in an upper and lower direction, through which the soldering portions 122 of the plurality of first terminals 12 are inserted. The protrusion 152 is provided with two second perforations 1521 communicated in an upper and lower direction, through which the soldering portions 132 of the two second terminals 13 are inserted. The body fixing portion 153 is mated with the retention plate fixing portion 115 in the body 11, such that the first retention element 15 is fixed on the rear end of the first body 11. The first retention element 15 is mated with the first and second terminals 12 and 13, so as to prevent the first and second terminals 12 and 13 from unsuitable bending.

Please see FIG. 4, the circuit board 2 soldered with the receptacle electrical connector 1 is provided with a plurality of first soldering holes 21 corresponding to the an flexible portions 122 of the plurality of first terminals 12, two second soldering holes 22 corresponding to the soldering portions 132 of the two second terminals 13, and four fixing holes 23 corresponding to the four fixing foots 144 of the first cage 14.

The assembly procedure of the receptacle electrical connector 1 is as follows: firstly inserting the first and second terminals 12 and 13 into the first body 11 in a direction of from rear to front; aligning the first retention element 15 with the soldering portions 122 of the first terminals 12 and the soldering portions 132 of the second terminals 13 and inserting the first retention element 15 in a direction of from upper to lower, until the body fixing portion 153 of the first retention element 15 is mated with the retention plate fixing portion 115 of the first body 11 such that the first retention element 15 is clasped with the first body 11; and then mounting the above formed assembly into the receiving chamber 145 of the first cage 14 in a direction of from rear to front; finally bending the fixing portion 146 located on the rear end of the first cage 14 as the shape shown in FIG. 11, and fixing the above assembly into the first cage 14.

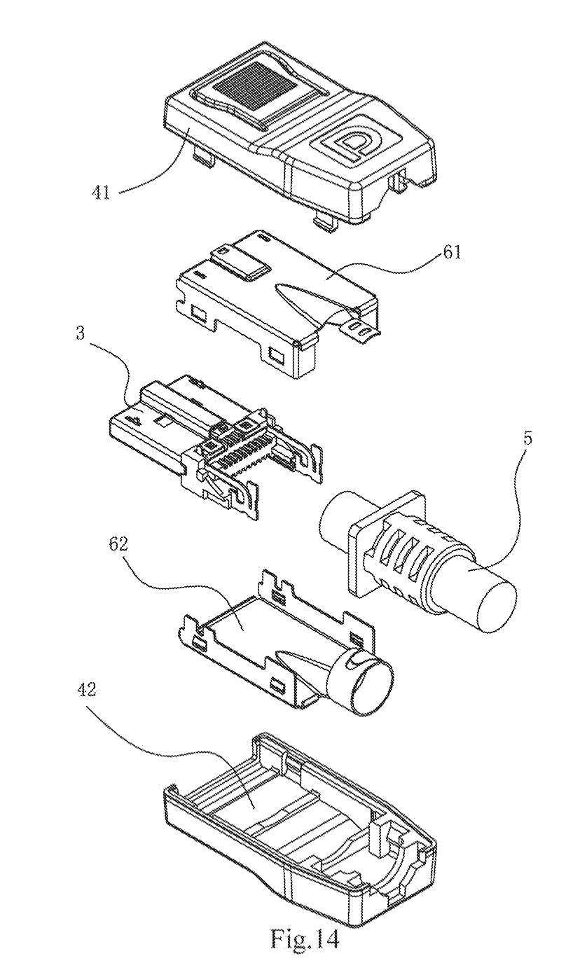

Referring to FIGS. 13 and 14, the plug electrical connector 3 can be electrically connected with a cable 5. The plug electrical connector 3, a metal inner housing 6 covering the connection position between the plug electrical connector 3 and the cable 5, and an insulated outer housing 4 are assembled together to form a cable connector. The insulated outer housing 4 is composed of an upper housing 41 and a lower housing 42 clasped with each other. The metal inner housing 6 is also composed of an upper housing 61 and a lower housing 62 clasped with each other.

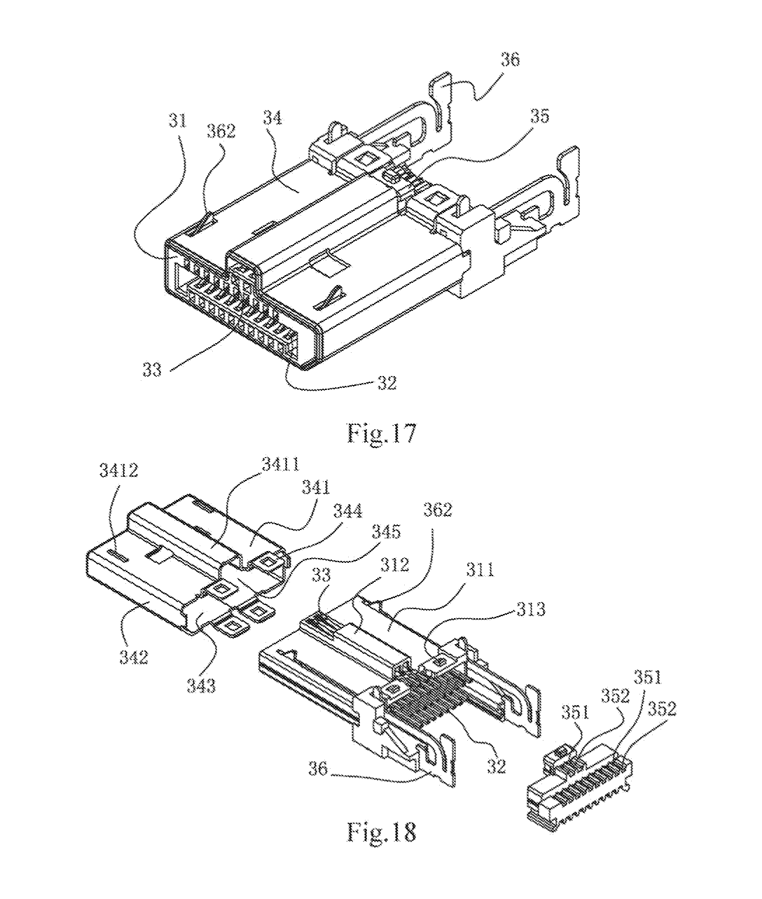

Referring to FIG. 17, the plug electrical connector 3 comprises a second body 31, a plurality of third terminals 32 and two fourth terminals 33 mounted on the second body 31; a second cage 34 mounted on an outside of the second body 31; a second retention element 35 mounted on a rear end of the second body 31; and two hooks 36 mounted on the second insulate body 31. Each of the hooks 36 has a hook portion 362 elastically movable up and down at its front end.

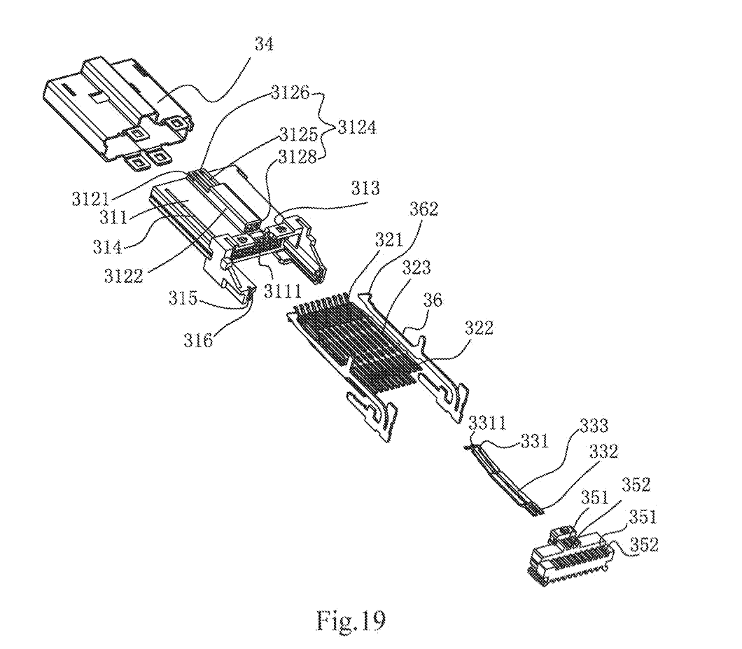

Referring to FIGS. 18 and 19, the second body 31 comprises a second main body portion 311; a second protrusion 312 protruding upwardly from a top of the second main body portion 311; two cage fixing portions 313 located on a rear end of the second main body portion 311; two hook receiving grooves 314 located on two sides of a front end of the second main body portion 311 respectively; and two hook fixing grooves 315 and two retention fixing portions 316 located on two sides of a rear end of the second main body portion 311 respectively. As for the present embodiment, the cage fixing portions 313 are sloped protrusion with a lower front and a higher rear. The second protrusion 312 has a step shape with a lower front and a higher rear, and comprises a relative lower first portion 3121 located on the front and a higher second portion 3122 located on the rear, and two fourth receiving slots 3124 by which the first and second portions 3121, 3122 are communicated with each other backward and forward.

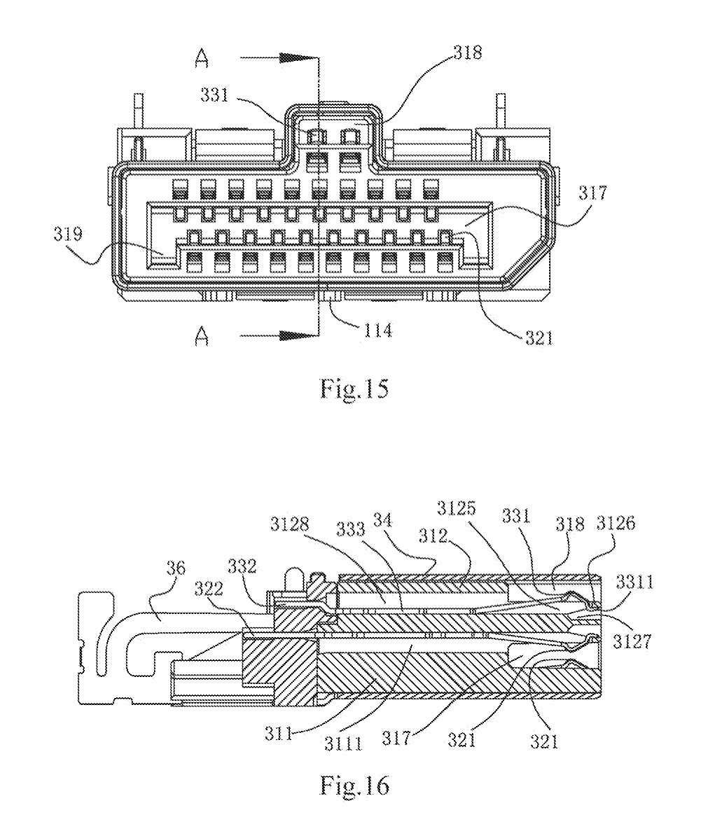

Referring to FIG. 15, the second main body portion 311 is provided with a third mating chamber 317 at its middle. In details, the third mating chamber 317 is recessed from the front end of the second main body portion 311. The third mating chamber 317 is provided with a plurality of third receiving slots 3111 at its upper and lower sides respectively. In addition, the third mating chamber 317 is provided with a polarizing groove 319 recessed downwardly therefrom at each of its left and right sides.

Referring to FIG. 16, a front half part of each of the fourth receiving slots 3124 is a groove 3125 recessed downwardly from a top of the first portion 3121 of the second protrusion 312. The second protrusion 312 is provided with a blocking portion 3126 at a front edge of the groove 3125, lower side of the blocking portion 3126 is running-through backward and forward. A rear half part of each of the fourth receiving slots 3124 is a through groove 3128 connected with the groove 3125 backward and forward and communicated with the second portion 3122 of the second protrusion 312.

The plurality of third terminals 32 comprises a mating portion 321, a soldering portion 322 and a fixing portion 323 connected between the mating portion 321 and the soldering portion 322. The mating portion 321 is elastic and has an arching protrusion shape. The mating portions 321 of those third terminals 32 are inserted into the third receiving slots 3111 on upper and lower sides of the third mating chamber 317, for transmitting high definition video signals. The mating portions 321 of the third terminals 32 on the upper side of the third mating chamber 317 are offset relative to those on the lower side of the third mating chamber 317, so as to reduce the interference of signals.

Referring to FIG. 16, two fourth terminals 33 are used to transmit power required by the display device. Each of the fourth terminals 33 comprises a mating portion 331, a soldering portion 332 and a fixing portion 333 connected between the mating portion 331 and the soldering portion 332. The mating portion 331 is elastic and has an arching protrusion shape, and inserted into the groove 3125 of the fourth receiving slot 3124 of the second protrusion 312 and located on the rear end of the blocking portion 3126. The blocking portion 3126 can protect the mating portion 331 from being damaging when the receptacle electrical connector 1 is inserted. The mating portion 331 has a free end 3311 movable up and down. The free end elastically abuts against the lower side of the blocking portion 3126. The fourth receiving slots 3124 is provided with a recessed portion 3127 recessed downwardly on the bottom under the free end 3311 of the mating portion 331 of the fourth terminals 33, so as to increase the movable space of the free end 3311 of the mating portion 331. The fixing portion 333 of the fourth terminals 33 is clasped into the through groove 3128 located on the rear end of the fourth receiving slots 3124.

Referring to FIG. 18, the second shielding 34 is formed by pressing a metal plate and comprises a top plate 341, two side plates 342 bending and extending downward from the top plate 341, a bottom plate 343 formed by bending the two side plates 342 toward each other and then engaging with each other, and four body fixing portions 344 protruding from the top plate 341 and the bottom plate 343 backwardly. As for the present embodiment, the body fixing portions 344 are four holes. The top plate 341, two side plates 342 and the bottom plate 343 of the second cage 34 enclose a receiving chamber 345 in a shape with a small upper portion and a big lower portion. The top plate 341 is provided with an inverted U shaped arching portion 3411 protruded upwardly at its middle, and a hook groove 3412 at each left and right sides at its front. The hook portion 362 of the two hooks 36 extend out upward from the hook groove 3412 on two sides of the upper surface of the second cage 34 respectively. The arching portion 3411 of the second cage 34 and the second protrusion 312 of the second body 31 enclose a fourth mating chamber 318. The mating portion 331 of the fourth terminal 33 extends out upwardly from the fourth receiving slot 3124 toward the fourth mating chamber 318. The third mating chamber 317 and the fourth mating chamber 318 are spaced apart and not communicated with each other by the second body 31. The third mating chamber 317 has a width larger than that of the fourth mating chamber 318.

The second retention element 35 is provided with through holes 351 running-through backward and forward, and a plurality of soldering line channels 352 located at a rear end of these through holes. These three terminals 32 and the four terminals 33 extend out backwardly through the through holes 351, and their soldering portions 322, 332 are received into the soldering line channels 352, so as to be facilitated to solder with wires in the cable 5.

The assembly procedure of the plug electrical connector 3 is as follows: inserting the third terminals 32 and the fourth terminals 33 into the third receiving slots 3111 and the fourth receiving slots 3124 of the second body 31 from rear to front; and then mounting the second retention element 35 on the rear end of the second body 311 from rear to front; finally inserting the above formed assembly into the receiving chamber 345 from rear to front, until the body fixing portion 344 of the second cage 34 is clasped with the cage fixing portion 313 of the second body 31.

In operation, when the above receptacle electrical connector 1 and the plug electrical connector 3 are mated together, the first and second tongues 112 and 113 of the receptacle electrical connector 1 are fitted with the third and fourth mating chambers 317 and 318 of the plug electrical connector 3 respectively, such that the plurality of first terminals 12 and the plurality of third terminals 32, two second terminals 13 and two fourth terminals 33 are electrically connected, so as to realize the video signal and power transmission between the video source device and the display device. As for the present embodiment, the two second terminals 13 can provide the display device with power supply (12V, 3A) to drive the display device. In other embodiments, the number and size of the second terminals 13 may increase to provide the display device with higher power supply.

In addition, the receptacle electrical connector 1 in accordance with the present embodiment can be mated with the standard DP type plug electrical connector (not shown, it can be regarded as a plug electrical connector 3 by omitting the second protrusion 312, the fourth terminals 33 and the arching portion 3411 of the second cage 34), so as to realize the video signal transmission between the video source device and the display device, and ensure the downward compatibility of the receptacle electrical connector 1.

As compared with the conventional connector, the plug electrical connector, the receptacle electrical connector and the electrical connector assembly in accordance with the first embodiment of the present disclosure have the following advantageous effects:

The mating portions 131 of the two second terminals 13 of the receptacle electrical connector 1 are arranged backward and forward, and one second terminal 13 with a distal 1311 closer to the front is used to connect with the negative pole of power source of the video source device, another second terminal 13 with a distal 1312 closer to the rear is used to connect with the positive pole of the power source of the video source device. By arranging like this, when the plug electrical connector 3 is disconnected with the receptacle electrical connector 1 in the display device, the plug electrical connector 3 is firstly disconnected with the distal 1312 of the second terminal 13 connected with the positive pole of the power source, and then disconnected with the distal 1311 of the second terminal 13 connected with the negative pole of the power source, such that the positive charge remained in the display device can be discharged outwardly via the second terminals 13 connected with negative pole of the power source which is disconnected lately. Therefore, the display device can be ensured to normally operate and advantageous to hot plug.

The distance between the two soldering portions 132 of the two second terminals 13 in the receptacle electrical connector 1 is larger than that between the two mating portions 131, and thusly the distance between the two mating portions 131 can be reduced, and on the other hand, two second soldering holes 22 with a relative large diameter can be advantageously formed on the circuit board 2, such that the second terminals 13 can be applied in the large-current environment. The mating portions 131 of the second terminals 13 on the receptacle electrical connector 1 have a plate shape, and are received into the second receiving slots 1131, 1132 located on the lower surface of the second tongue 113, and thusly the structures of the mating portions 131 of the second terminals 13 are easy to manufacture, at the same time, the distance between the two mating portions 131 can be reduced, so as to reduce the width occupied by the second mating chamber 1452. Therefore, the two clasp arms 1415 on the top plate 14 of the first cage 14 can be remained, so as to have the downward compatibility to the standard DP type plug.

The second protrusion 312 of the plug electrical connector 3 is provided with the two fourth receiving slots 3124, the mating portions 331 of the fourth receiving slots 3124 are elastic and have a protrusion shape, and the mating portions 331 are protruded out upwardly from the fourth receiving slots 3124 toward the fourth mating chamber 318, therefore, the mating portions 331 of the fourth terminals 33 can be protected by the second protrusion 312, and are not easily bent during the mating with the receptacle electrical connector 1.

In addition, the contacting portion 121 of the first terminals 12 on the receptacle electrical connector 1 are offset relative to the contacting portion 321 of the third terminals 32 on the plug electrical connector 3, so as to reduce the signal noise during the transmission and improve the signal transmission quality.

It should be noted that, for the clarity sake, the above first embodiment is explained with reference to the HPDP (High Power Display Port) electrical connector which is newly added the power supply function on the basis of the standard DP (Display Port) electrical connector, however, the present disclosure also can be applied into the other type electrical connector (such as HDMI electrical connector) to add the power supply function.

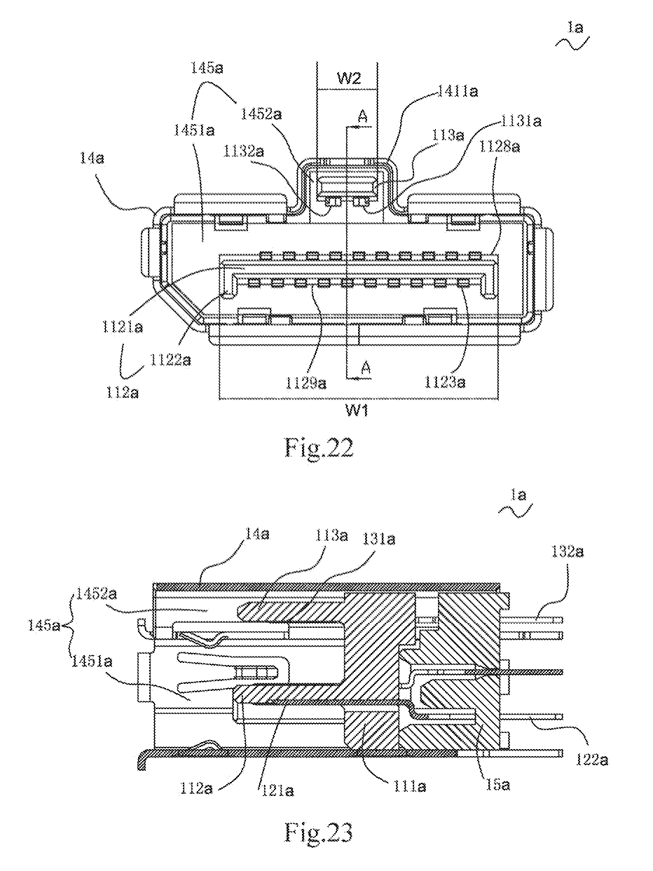

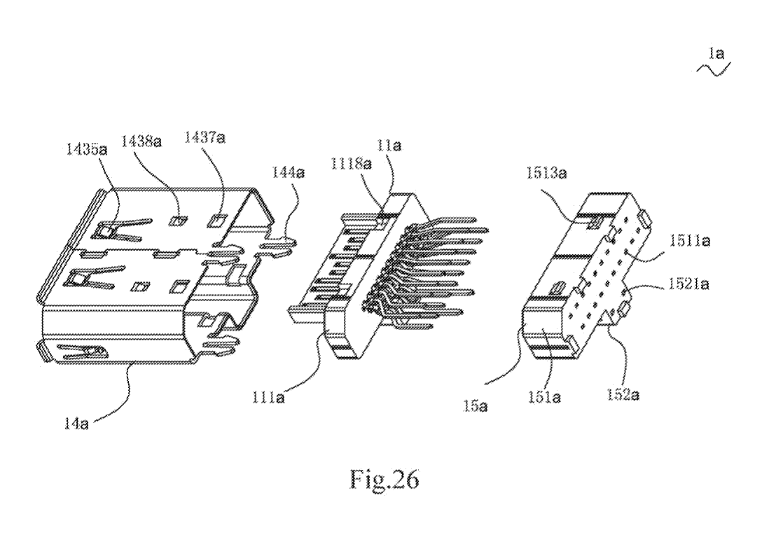

The second embodiment of the receptacle electrical connector as shown in FIGS. 22-26 is a receptacle electrical connector 1a adapted to be vertically mounted on a corresponding circuit board (not shown). The receptacle electrical connector 1a comprises a first body 11a, a plurality of first terminals 12a and two second terminals 13a mounted on the first body 11a, a first cage 14a mounted on the first body 11a and a first retention element 15a hold on the first cage 14a and abut against a rear end of the first body 11a.

The first body 11a comprises a first main body portion 111a, a first tongue 112a and a second tongue 113a extending forward from the first main body 111a. Each of the opposite side surfaces of the first main body portion 111a is provided with two first retention portions 1118a.

The first tongue 112a comprises a base 1121a in a plate shape and two keying ribs 1122a protruding downward from a left and right side edge of the base 1121a respectively. The two keying ribs 1122a of the first tongue 112a can prevent the other different type plugs from wrongly inserting into the receptacle electrical connector 1a due to. The base 1121a of the first tongue 112a comprises a first surface 1128a and a second surface 1129a opposite with each other. The first surface 1128a is configured to face upward and the second surface 1129a is configured to face downward. Each of the first and second surfaces 1128a and 1129a is provided with a plurality of first receiving slots 1123a. The first tongue 112a can be mated with a standard DP (Display Port) type plug electrical connector.

The first and second tongue 112a and 113a are configured to be parallel with each other and arranged in an upper and lower relationship. The first tongue 112a has a width W1 larger than that W2 of the second tongue 113a. Two second receiving slots 1131a, 1132a are provided in a lower surface of the second tongue 113a.

The first terminals 12a can be divided into upper and lower rows. Each of the first terminals 12a has a mating portion 121a in a plate shape and a soldering portion 122a. The mating portions 121a of the first terminals 12a are provided in first receiving slots 1123a of the first tongue 112a, for transmitting high definition video signals. The mating portions 121a of the first terminals 12a located on the upper surface 1128a of the first tongue 112a are offset relative to those on the lower surface 1129a of the first tongue 112a, that is, the mating portions 121a in an upper row are not faced to the mating portions 121a in a lower row, such that the distance between the mating portions 121a of the upper row first terminals and the lower row first terminals can be increased, thusly reducing the signal noises during the high frequency data transmission and improving the signals transmitting quality.

Each of the second terminals 13a comprises a mating portion 131a in a plate shape and a soldering portion 132. The two second terminals 13a are received in the two second receiving slots 1131a, 1132a respectively. One second terminal 13a received in the second receiving slot 1131a is used to connect with the negative pole of the power source, and the other second terminal 13a is used to connect with the positive pole of the power source. A distal of the mating portion 131a of the one second terminal 13a connected to the negative pole of the power source is located at a position closer to the front on the second tongue 113a compared with a distal of the mating portion 131a of the other second terminal 13a connected to the positive pole of the power source, such that the positive charge remained in the inner of the display device can be discharged via the plug electrical connector through the second terminal 13a connected with the negative pole of the power source which are disconnected later when hot plugging, and thusly the display device can be ensured to operate normally. The two second terminals 13a are used to transmit the power required by the display device, so as to save one separate power cable of the display device. In addition, the distance between the soldering portions 132a is larger than that of the mating portions 131a of the two second terminals 13a, such that the distance between the two corresponding soldering holes in the circuit board can be increased to suitably increase the current.

The first cage 14a encloses the first and second tongue 112a and 113a to form a receiving chamber 145a. A first mating chamber 1451a enclosing the first tongue 112a is formed around the first tongue 112a, in which a standard DP plug can be inserted. A second mating chamber 1452a enclosing the second tongue 113a is formed around the second tongue 113a. The first mating chamber 1451a has a width larger than that of the second mating chamber 1452a. The first and second mating chambers 1451a and 1452a are stacked and communicated with each other to form the first receiving chamber 145a. In details, the first cage 14a is formed by pressing a metal plate and has a shape with a small upper portion and a larger lower portion.

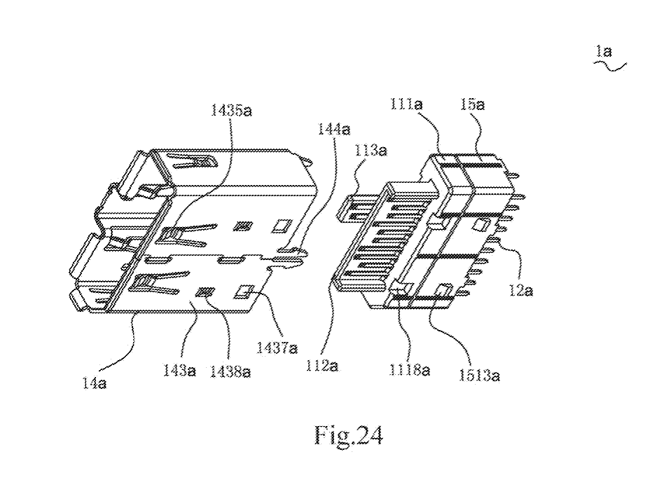

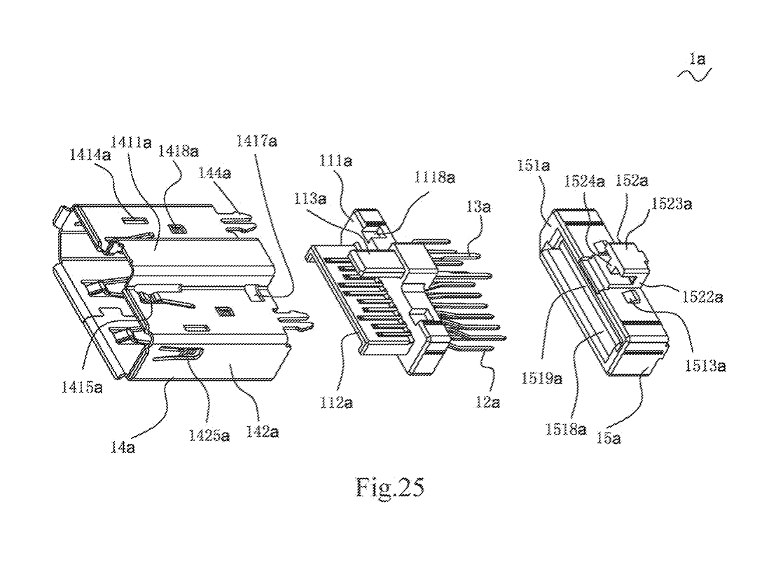

As shown in FIGS. 24 and 25, the first cage 14a comprises a top plate 141a, two side plates 142a bending and extending downward from left and right sides of the top plate 141a, a bottom plate 143a formed by horizontally bending and extending the two side plates 142a toward each other and engaging with each other, and four fixing foots 144a straightly extending backward from the rear ends of the top plate 141a and the bottom plate 143a. An arching portion 1411a in an invert U shape extends upward from a middle of the top plate 141a. The top plate 141a is provided with a hole 1414a on each of the left and right of the arching portion 1411a and a clasp portion 1417a on each of the left and right sides of the arching portion 1411a. The top plate 141a is provided with a limiting portion 1418a protruding inwardly on each front ends of the two clasp portions 1417a. Similarly, the bottom plate 143a is also provided with a clasp portion 1417a and two limiting portions 1418a. Those limiting portions 1418a, 1438a can be mated with the first retention portion 1118a of the first body 11a to orientate the first body 11a relative to the first cage 14a. The top plate 141a is provided with a flexible clasp arm 1415a extending from rear to front on each left and right of the arching portion 1411a. The bottom plate 143a is provided with a flexible clasp arm 1435a extending from rear to front on each of the left and right portion thereof. Each of the two side plates 142a is provided with a flexible clasp arm 1425a extending from front to rear. Those elastic arms 1414a, 1425a, 1435a can be clasped on the different sides and positions in different depths of the plug electrical connector to improve the engaging strength.

The first retention element 15a is mated with the soldering portions of the first and second terminals 12a, 13a, so as to prevent the soldering portions of those terminals from breaking and shorting out. In details, the first retention element 15a comprises a base 151a and a protrusion 152a extending from the upper surface of the opposite two surfaces of the base 151a. The base 151a is provided with a plurality of perforations 1511a for inserting the first terminals 12a. A groove 1518a in which a partition plate 1519a is provided is recessed backwardly from the front end of the base 151a. The two rows of first terminals 12a are inserted and received into the groove 1518a and arranged on the two sides of the partition plate 1519a. The base 151a is provided with two clasp portions 1513a on each of the upper and lower surfaces thereof, such that the clasp portions can be mated with the clasp portions 1417a, 1737a on the first cage 14a to mount the first retention element 15a onto the first cage 14a and abut the first retention element 15a against the rear end of the first body 11a.

As depicted, a holding portion 1513a is a holding protrusion which protrudes outwardly from the base 151a with a slope at its front end. The clasp portions 1417a, 1437a are openings in the first cage 14a. In the other embodiment, the holding portion 1513a may be a holding groove recessed inwardly from the base 151a instead, and the clasp portions 1417a, 1437a are holding elastic sheets (not shown) protruding toward the inner of the first receiving chamber 145a instead.

The protrusion 152a is provided with two second perforations 1521a for inserting the second terminals 13a. The protrusion 152a comprises a vertical wall 1522a extending vertically from the rear end of the upper surface of the base 151a, a top plate 1523a extending forwardly from the top end of the vertical wall 1522a, and a partition plate 1524a extending vertically from the bottom of the top plate 1523a. The vertical wall 1522a is provided with a second perforation 1521a on each of the two sides of the partition plate 1524a.

The assembly procedure of the receptacle electrical connector 1a is as follows: firstly inserting the first and second terminals 12a and 13a into the first body 11a in a direction of from rear to front; and then covering the first cage 14a onto the first body 11a in a direction of from front to rear; and finally aligning the first retention element 15a with the soldering portions of those terminals and inserting the first retention element 15a in a direction of from rear to front, such that the first retention element 15a is fixed on the first cage 14a and abut against the rear end of the first body 11a.

It should be noted that although the number of the above second terminals 13a is two, it can be three or four or the other number larger than two in the other possible embodiment, so as to improve the supplied power.

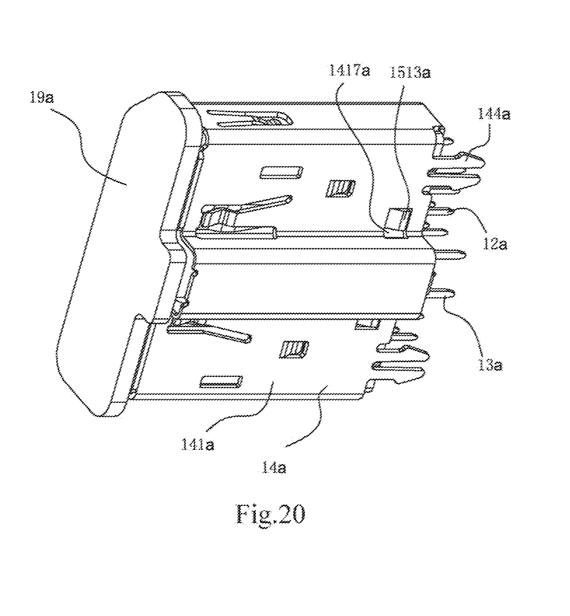

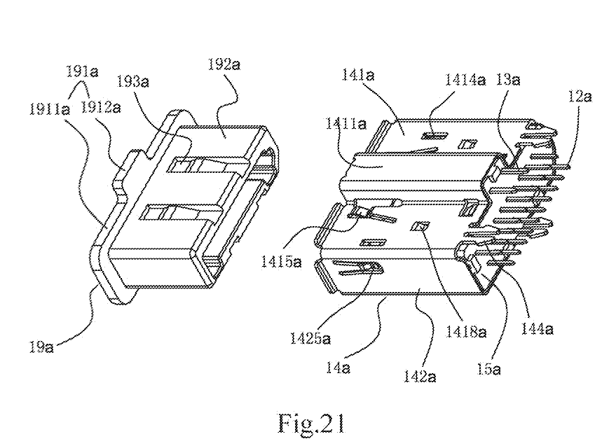

Referring to FIGS. 20 and 21, the receptacle electrical connector 1a further comprises a sealed cap 19a which has a panel 191a and an extension 192a extending backwardly from the panel 191a. The extension 192a is provided with a plurality of buckle portions 193a at its periphery. The shape of the panel 191a is corresponding to the opening shape of the first receiving chamber 145a. The panel 191a has a base 1911a for sealing the first mating chamber 1451a, and a protrusion 1912a for sealing the second mating chamber 1452a. The buckle portions 193a can be engaged with the flexible clasp arms 1415a, 1435a in the first cage 14a when the sealing cap 19a is inserted into the first receiving chamber 145a, such that the opening of the first receiving chamber 145a is sealed by the panel 191a.

As compared with the conventional connector, in addition to the advantageous effects of the first embodiment, the receptacle electrical connector 1a in accordance with the second embodiment of the present disclosure has the following advantageous effects: the combination between the first body 11a and the first cage 14a can be enhanced since the first retention element 15a is mounted on the first cage 14a and abut against the rear end of the first body 11a, such that the terminals can be prevented from bending.

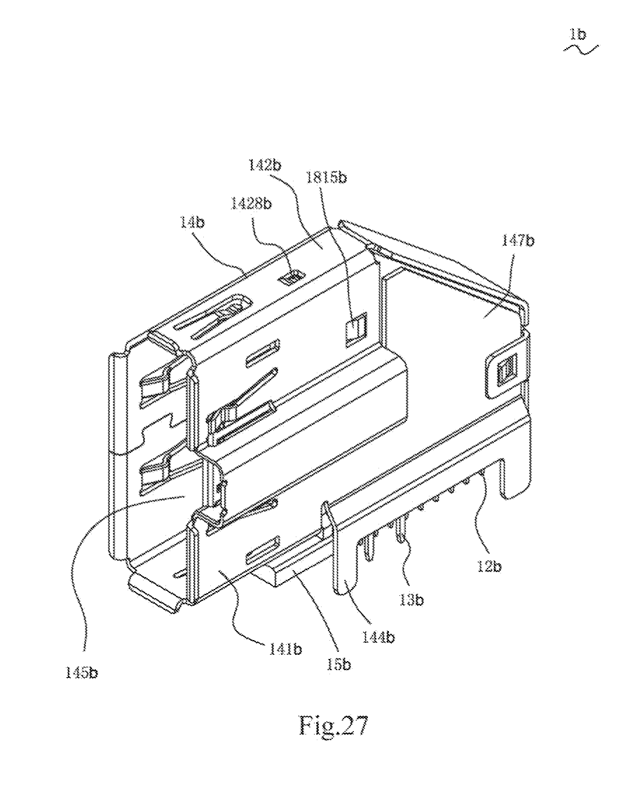

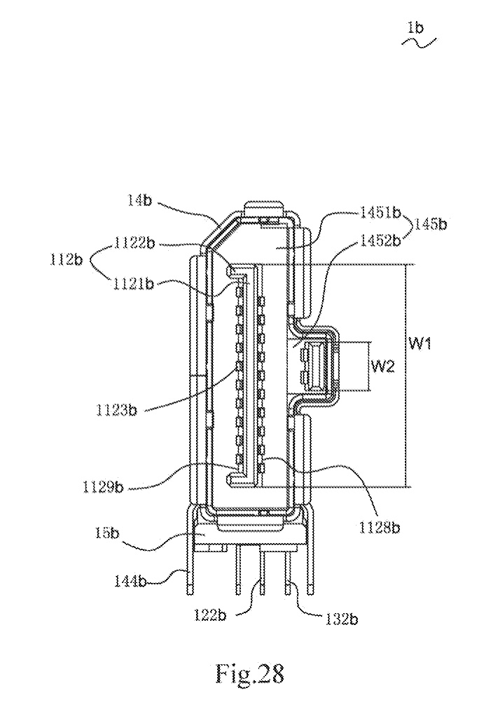

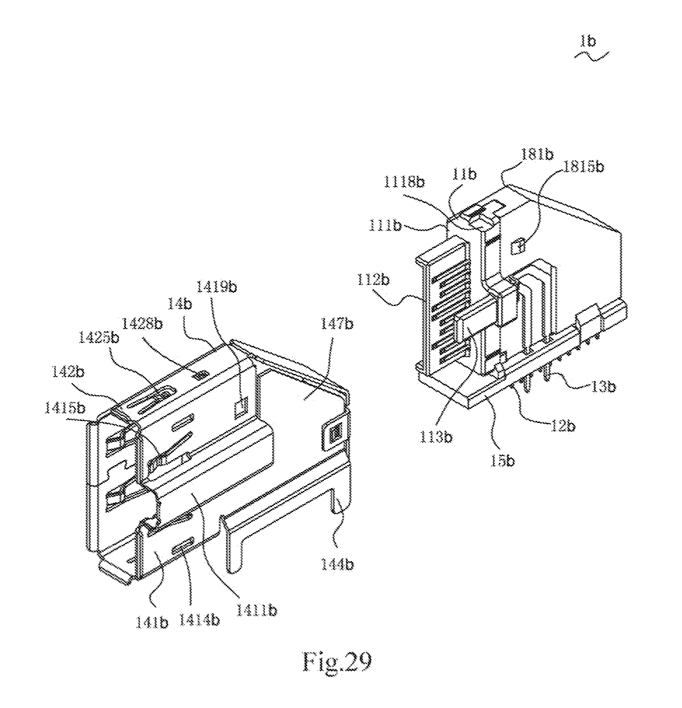

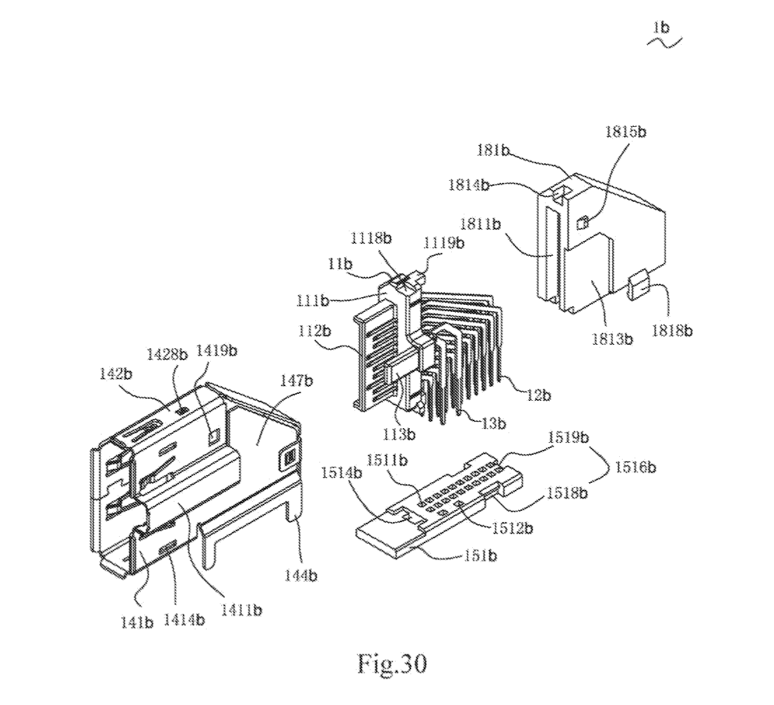

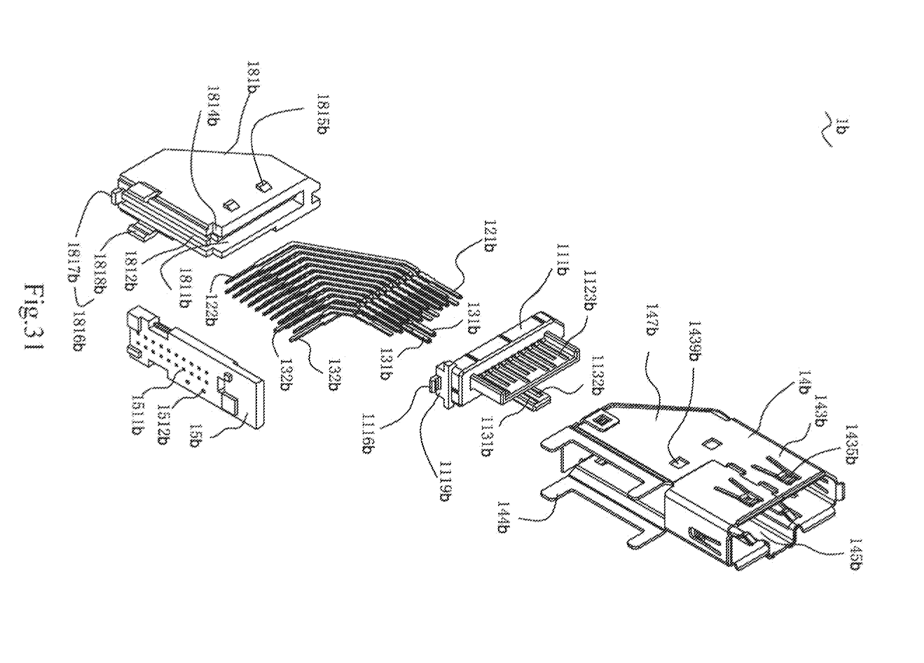

A third embodiment of the receptacle electrical connector is shown in FIGS. 27-31 and includes a receptacle electrical connector 1b adapted to be side-mounted on a corresponding circuit board (not shown). The receptacle electrical connector 1b comprises a first body 11b, a plurality of first terminals 12b and two second terminals 13b mounted on the first body 11b, a terminal protecting seat 181b mounted on a rear end of the first body 11b, a first cage 14b mounted on an outside of the first body 11b and the terminal protecting seat 181b, and a first retention element 15b mounted under the first cage 14b and combined with the first body 11b and the terminal protecting seat 181b.

The first body 11b comprises a first main body portion 111b, a first tongue 112b and a second tongue 113b extending forward from the first main body 111b. The first main body portion 111b of the first body 11b is provided with a front retention portion 1118b. The first main body portion 111b of the first body 11b is also provided with a first retention portion 1119b on two ends of the rear portion thereof. In addition, a first clasp portion 1116b extends downwardly from the first main body portion 111b of the first body 11b.

The first tongue 112b comprises a base 1121b in a plate shape and two keying ribs 1122b protruding toward left side from two side edges of top and bottom of the base 1121c respectively. The base 1121b of the first tongue 112b comprises a first surface 1128b and a second surface 1129b opposite with each other. The first surface 1128b is configured to face rightward and the second surface 1129b is configured to face leftward. Each of the first and second surfaces 1128b and 1129b is provided with a plurality of first receiving slots 1123b. The first tongue 112b can be mated with a standard DP (Display Port) type plug electrical connector.

The first and second tongue 112b and 113b are configured to be parallel with each other and arranged in a left side and right side relationship. The first tongue 112b has a width W1 larger than that W2 of the second tongue 113b.

Two second receiving slots 1131b, 1132b are provided in a surface facing leftward of the second tongue 113b.

The first terminals 12b can be divided into upper and lower rows which are inserted into the first body lib. Each of the first terminals 12b has a mating portion 121b in a plate shape and a soldering portion 122b. The mating portions 121b of the first terminals 12b are provided in first receiving slots 1123b of the first tongue 112b, for transmitting high definition video signals. The mating portions 121b of the first terminals 12b located on the first surface 1128b of the first tongue 112b are offset relative to those on the second surface 1129b of the first tongue 112b, that is, the mating portions 121b on a left side are not faced with the mating portions 121b on a right side.

The two second terminals 13b are inserted into the two second receiving slots 1131b, 1132b of the first body 11b. Each of the second terminals 13b comprises a mating portion 131b in a plate shape and a soldering portion 132b. One second terminal 13b received in the corresponding second receiving slot 1131b is used to connect with the negative pole of the power source, and the other second terminal is used to connect with the positive pole of the power source. A distal of the mating portion 131b of the one second terminal 13b connected to the negative pole of the power source is located at a position closer to the front compared with a distal of the mating portion 131b of the other second terminal 13b connected to the positive pole of the power source. The two second terminals 13b are used to transmit the power required by the display device, so as to save one separate power cable of the display device. In addition, the distance between the two soldering portions 132b is larger than that between the two mating portions 131b of the two second terminals 13b.

As shown in FIGS. 30 and 31, the terminal protecting seat 181b is mounted on a rear end of the first body 11b, and provided with a receiving slot 1811b recessed in a middle of the terminal protecting seat 181b and a partition wall 1812b located in the receiving slot 1811b. The receiving slot 1811b is divided into left and right parts by the partition wall 1812b for receiving the two rows of first terminals 12b. The terminal protecting seat 181b is provided with a groove 1813b on the right side thereof for receiving the second terminals 13b. The terminal protecting seat 181b is also provided with a first combining portion 1814b on each of the top and bottom ends on a front thereof for mating with the two first retention portions 1119b of the first body 11b, such that the terminal protecting seat 181b is fixed on the rear end of the first body 11b. In addition, the terminal protecting seat 181b is provided with two clasp portions 1815b on each of left and right sides thereof. The terminal protecting seat 181b is also provided with a first buckle portion 1816b under the rear end thereof. The first buckle portion 1816b comprises two opposite buckles 1818b extending downwardly from the left and right sides closer to the rear end thereof respectively, and a limiting block 1817b extending downwardly from the rear end thereof.

The first cage 14b encloses the first and second tongue 112b and 113b to form a receiving chamber 145b. A first mating chamber 1451b enclosing the first tongue 112b is formed around the first tongue 112b, in which a standard DP plug can be inserted. A second mating chamber 1452b enclosing the second tongue 113b is formed around the second tongue 113b. The first mating chamber 1451b has a width larger than that of the second mating chamber 1452b. The first and second mating chambers 1451b and 1452b are stacked and communicated with each other to form the first receiving chamber 145b. In details, the first cage 14b is formed by pressing a metal plate and has a shape with a small upper portion and a larger lower portion.

The first cage 14b comprises a right side plate 141b, a top plate 142b and a bottom plate 142b bending and extending leftward in a horizontal direction from top and bottom of the right side plate 141b respectively, a left side plate 143b formed by further vertically bending and extending the top plate 142b and the bottom plate 142b toward each other and then engaging with each other, and an extension 147b formed by extending backwardly and combining the right side plate 141b, left side plate 143b and the top plate 142b. The extension 147b covers the rear ends of the first body 11b and the terminal protecting seat 181b.

An arching portion 1411b in an invert U shape protrudes rightward from a middle of the right side plate 141b. The right side plate 141b is provided with a hole 1414b on each of the upper and lower portions of the arching portion 1411b. The arching portion 1411b is provided with a mounting portion 1419b on each side thereof. Similarly, the right side plate 143b is also provided with two mounting portions 11439b. Those mounting portions 1419b, 1439b can be mated with the clasp portions 1815b of the terminal protecting seat 181b, for fixing the terminal protecting seat 181b onto the first cage 14b. In addition, the top plate 142b is provided with a limiting portion 1428b which is mated with the front retention portion 1118b of the first body 11b to orientate the first body 11b at the rear end of the first cage 14b.

In addition, the right side plate 141b is provided with a flexible clasp arm 1415b extending from rear to front on each upper and lower sides of the arching portion 1411b. The left side plate 143b is provided with a flexible clasp arm 1435b extending from rear to front on each of the upper and lower portions thereof. Each of the top and bottom plates 142b is provided with a flexible clasp arm 1425b extending from front to rear.

The first retention element 15b and the terminal protecting seat 181b are mated with the first and second terminals 12b, 13b, so as to prevent the soldering portions of those terminals from bending. In details, the first retention element 15a is mounted under the first body 11b and the terminal protecting seat 181b, and comprises a base 151b. The base 151b is provided with a plurality of first perforations 1511b for inserting the first terminals 12b, two second perforations 1512b for inserting the second terminals 13b. The first retention element 15a is also provided with a first mounting portion 1514b for mating with the first clasp portion 1116b of the first body 11b, and a second buckle portion 1516b for mating with the first buckle portion 1816b of the terminal protecting seat 181b. In details, the first mounting portion 1514b is a hole. The second buckle portion 1516b comprises two snap grooves 1518b located at a position closer to the rear end and mated with the two buckles 1818b of the first buckle portion 1816b, and a retention groove 1519b located on the rear end and mated with the limiting block 1817b of the first buckle portion 1816b.

The assembly procedure of the receptacle electrical connector 1b is as follows: firstly inserting the first and second terminals 12b and 13b into the first body 11b in a direction of from rear to front; and then inserting the terminal protecting seat 181b on the rear end of the first body 11b in a direction of from rear to front; and aligning the first retention element 15b with the soldering portions of those terminals and inserting the first retention element 15b in a direction of from lower to upper, and combining the first retention element 15b with the first body 11b and the terminal protecting seat 181b, finally, covering the first cage 14b onto the above parts in a direction of from front to rear.

As compared with the conventional connector, in addition to the advantageous effects of the first embodiment, the receptacle electrical connector 1b in accordance with the third embodiment of the present disclosure has the following advantageous effects: the terminals 12b, 13b can be ensured to extend longer and not easily bend when side-mounting by mounting the terminal protecting seat 181b on the rear end of the first body 11b.

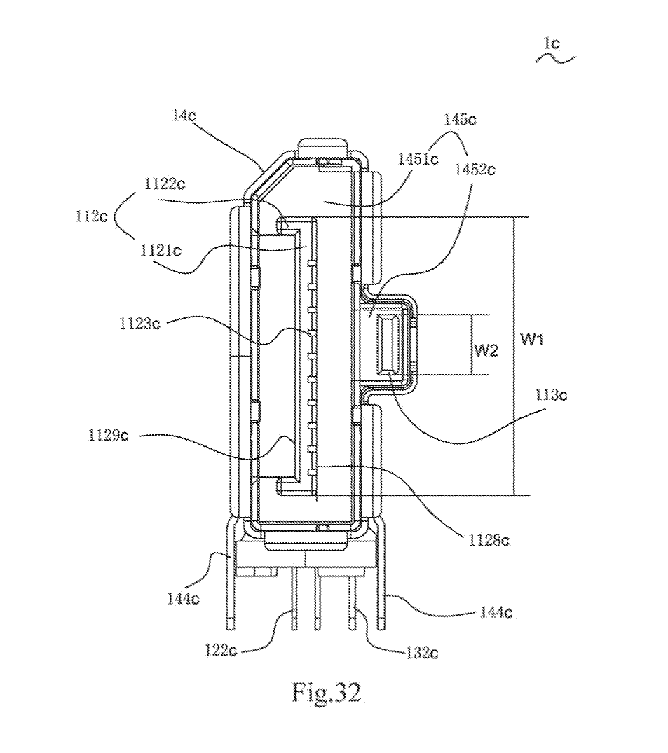

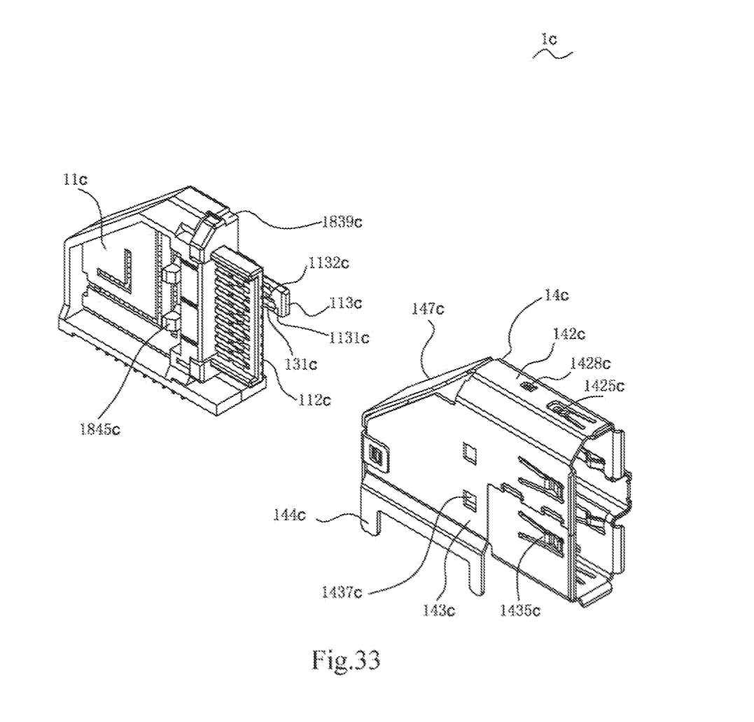

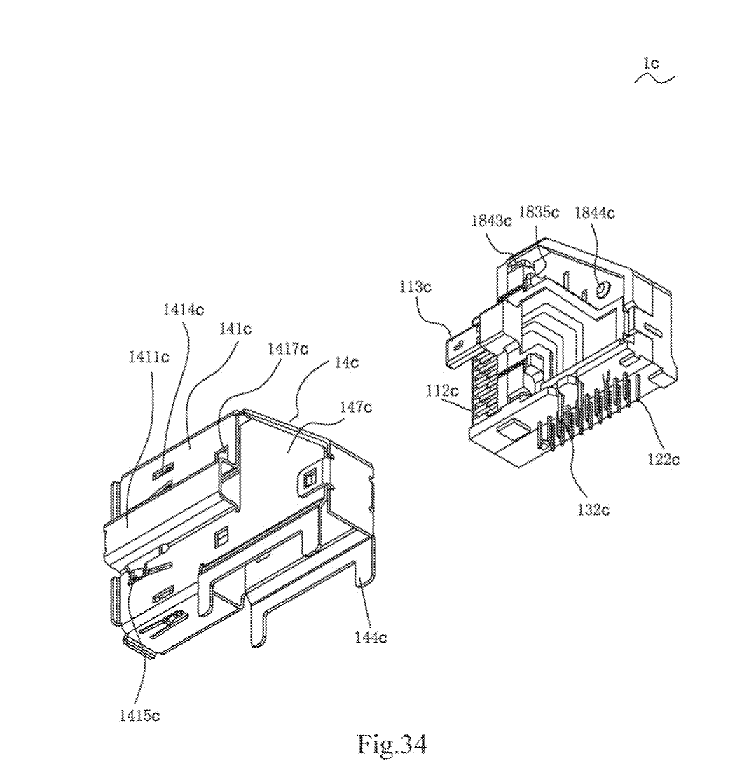

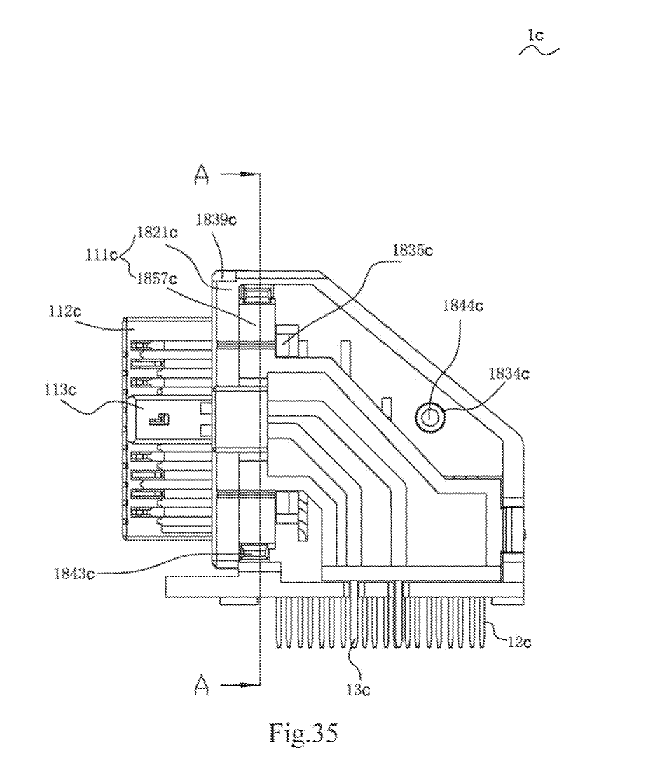

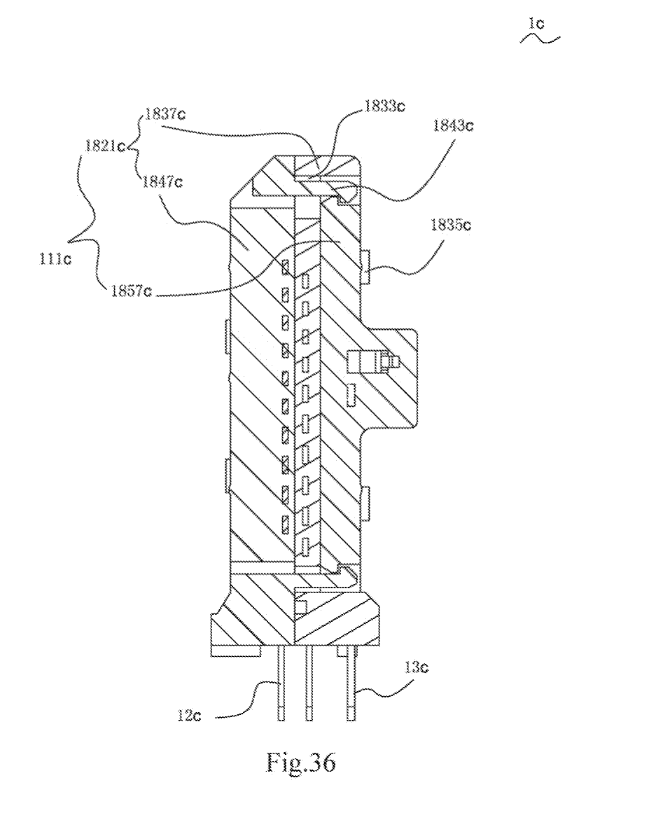

A fourth embodiment of the receptacle electrical connector is shown in FIGS. 32-38 and includes a receptacle electrical connector 1c adapted to be side-mounted on a corresponding circuit board (not shown). The receptacle electrical connector 1c comprises a first body 11c, a plurality of first terminals 12c and two second terminals 13c mounted on the first body 11c, a first cage 14c mounted on an outside of the first body 11c.

The first body 11c comprises a first main body portion 111c, a first tongue 112c and a second tongue 113c extending forward from the first main body 111c. The first tongue 112c comprises a base 1121c in a plate shape and two keying ribs 1122c protruding toward left side from two side edges of top and bottom of the base 1121c respectively. The base 1121c of the first tongue 112c comprises a first surface 1128c and a second surface 1129c opposite with each other. The first surface 1128c is configured to face rightward and the second surface 1129c is configured to face leftward. Each of the first and second surfaces 1128c and 1129c is provided with a plurality of first receiving slots 1123c.

The first and second tongue 112c and 113c are configured to be parallel with each other and arranged in a left side and right side relationship. The first tongue 112c has a width W1 larger than that W2 of the second tongue 113c. Two second receiving slots 1131c, 1132c are provided in a surface facing leftward of the second tongue 113c.

Each of the first terminals 12c has a mating portion 121c in a plate shape and a soldering portion 122c. The mating portions 121c of the first terminals 12c are provided in first receiving slots 1123c of the first tongue 112c, for transmitting high definition video signals. The mating portions 121c of the first terminals 12c located on the first surface 1128c of the first tongue 112c are offset relative to those on the second surface 1129c of the first tongue 112c, that is, the mating portions 121c are not faced with each other in a left side and right side direction.

Each of the second terminals 13c comprises a mating portion 131c in a plate shape and a soldering portion 132c. The two second conductive electrical terminals 13c are received into the two receiving slots 1131c, 1132c respectively. One second terminal 13c received in the corresponding second receiving slot 1131c is used to connect with the negative pole of the power source, and the other second terminal 13c is used to connect with the positive pole of the power source. A distal of the mating portion 131c of the one second terminals 13c connected to the negative pole of the power source is located at a position closer to the front compared with a distal of the mating portion 131c of the other second terminals 13c connected to the positive pole of the power source. The two second terminals 13c are used to transmit the power required by the display device, so as to save one separate power cable of the display device. In addition, the distance between the two soldering portions 132c is larger than that between the two mating portions 131c of the two second terminals 13c.

In the present embodiment, the main body portion 111c of the first body 11c comprises a first body assembly 1821c and a second body 1857c coupling with each other. The first tongue 112c extends forward from the first body assembly 1821c, and the second tongue 113c extends forward from the second body 1857c. The first terminal 12c is partly insert-molded in the first body assembly 1821c.

A receiving slot 1838c in which two hooks 1843c are provided is formed in the first body assembly 1821c. The second body 1857c is provided with two snap grooves 1859c which are clasped with the two hooks 1843c, such that the second body 1857c is received into the receiving slot 1838c.

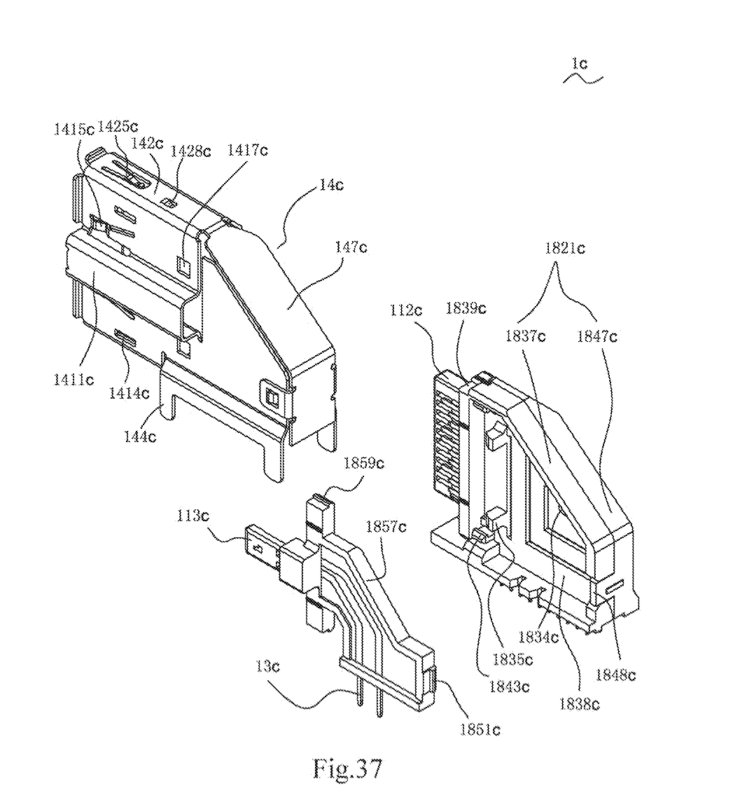

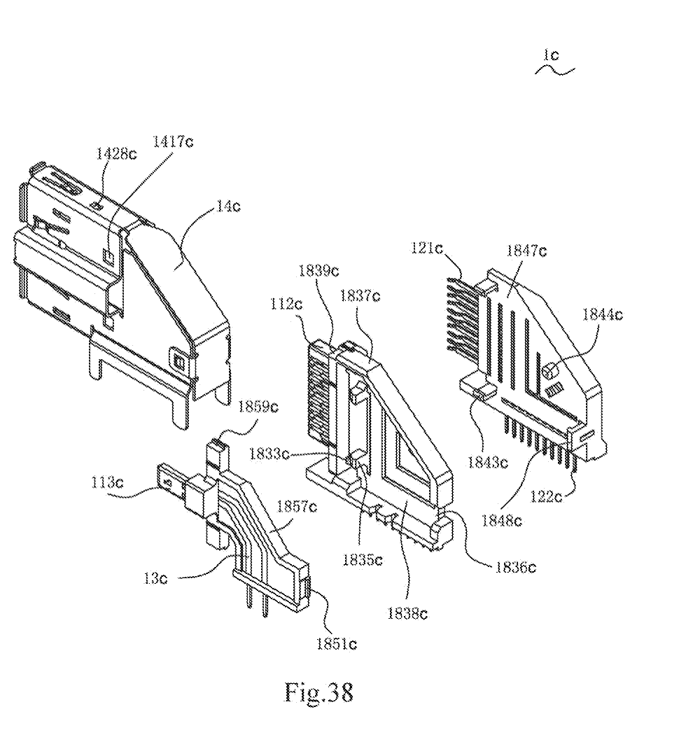

The first body assembly 1821c can be configured in many different structures, in the present embodiment, as shown in FIGS. 37 and 38, the first body assembly 1821c comprises a first body 1837c and a third body 1847c coupled with each other. The first tongue 112c extends forward from the first body 1837c. The plurality of first terminals 12c are divided into a first row of first terminals which are partly insert-molded in the first body 1837c, and a second row of first terminals which are partly insert-molded in the third body 1847c, the mating portions 121c of the first row are inserted-molded into the first receiving slots 1123c in the first surface 1128c of the first tongue 112c, the mating portions 121c of the second row are inserted into the first receiving slots 1123c in the second surface 1129c of the first tongue 112c. A second retention portion 1839c is provided at the top of the first body assembly 1821c.

As for the embodiment shown in FIG. 38, two hooks 1843c are provided in the third body 1847c. The above receiving slot 1838c in which perforations 1833 for inserting the two hooks 1843c are provided is formed in the first body 1837c. The third body 1847c is provided with a retention portion 1844c, and the first body 1837c is provided with a retention coupling portion 1834c which is coupled with the retention portion 1844c to realize the relative fixation between the first body 1837c and the third body 1847c. The above second retention portion 1839c is provided at the top of the first body 1837c.

In addition, the third body 1847c is further provided with a third hook 1848c. The first body 1837c is provided with a notch 1836c for avoiding interference with the third hook 1848c. The second body 1857c is also provided with a third snap groove 1851c for mating with the third hook 1848c on the rear end of the second body. Own to the above structure, the connection between the second body 1857c and the first body assembly 1821c is more reliable.

The first cage 14c encloses the first and second tongue 112c and 113c to form a first receiving chamber 145c. A first mating chamber 1451c enclosing the first tongue 112c is formed around the first tongue 112c, in which a standard DP plug can be inserted. A second mating chamber 1452c enclosing the second tongue 113c is formed around the second tongue 113c. The first mating chamber 1451c has a width larger than that of the second mating chamber 1452c. The first and second mating chambers 1451c and 1452c are stacked and communicated with each other to form the first receiving chamber 145c. In details, the first cage 14c is formed by pressing a metal plate and has a shape with a small upper portion and a larger lower portion.

The first cage 14c comprises a right side plate 141c, a top plate 142c and a bottom plate 142c bending and extending leftward in a horizontal direction from top and bottom of the right side plate 141c respectively, a left side plate 143c formed by further vertically bending and extending the top plate 142c and the bottom plate 142c toward each other and then engaging with each other, and an extension 147c formed by extending backwardly and combining the right side plate 141c, left side plate 143c and the top plate 142c. The extension 147c covers the rear ends of the first body 11c and has four fixing foots 144c extending downward.

An arching portion 1411c in an invert U shape protrudes rightward from a middle of the right side plate 141c. The right side plate 141c is provided with a hole 1414c on each of the upper and lower sides of the arching portion 1411c. The arching portion 1411c is provided with a mounting portion 1417c on each side thereof. Similarly, the right side plate 143c is also provided with two mounting portions 1437c. Those mounting portions 1417c, 1437c can be mated with the clasp portions 1835c, 1845c of the first body 11c, for fixing the first body 11c onto the first cage 14c. In addition, the top plate 142c is provided with a limiting portion 1428c which can be mated with the second retention portion 1839c of the first body 11c to orientate the first body 11c at the rear end of the first cage 14c.

In addition, the right side plate 141c is provided with a flexible clasp arm 1415c extending from rear to front on each upper and lower sides of the arching portion 1411c. The left side plate 143c is provided with a flexible clasp arm 1435c extending from rear to front on each of the upper and lower portion thereof. Each of the top and bottom plates 142c is provided with a flexible clasp arm 1425c extending from front to rear. Those elastic arms 1414c, 1425c, 1435c can be clasped on the different sides and positions in different depths of the mating electrical connector to improve the engaging strength.

The assembly procedure of the receptacle electrical connector 1c is as follows: firstly molding the first body 1837c, the second body 1857c and the third body 1847c on the periphery of the two rows first terminals 12c and the second terminals 13c respectively by using the insert-molded technology; then assembling the first body 1837c and the third body 1847c to form a first body assembly 1821c; and then assembling the first body assembly 1821c and the second body 1857c to form the first main body portion 111c of the first body 11c; and finally, covering the first cage 14c onto the first body 11c in a direction of from front to rear.

As compared with the conventional connector, in addition to the advantageous effects of the first embodiment, the receptacle electrical connector 1c in accordance with the fourth embodiment of the present disclosure has the following advantageous effects: the terminals 12c, 13c can be ensured to extend longer and not easily bend and suitable to be side-mounted, this is because the first main body portion 111c of the first body 11c is divided into the first body 1837c, the second body 1857c and the third body 1847c which can be coupled and assembled together, and the above terminals 12c, 13c can be fixed on the above different bodies 1837c, 1847c, 1857c by using the insert-molded technology.

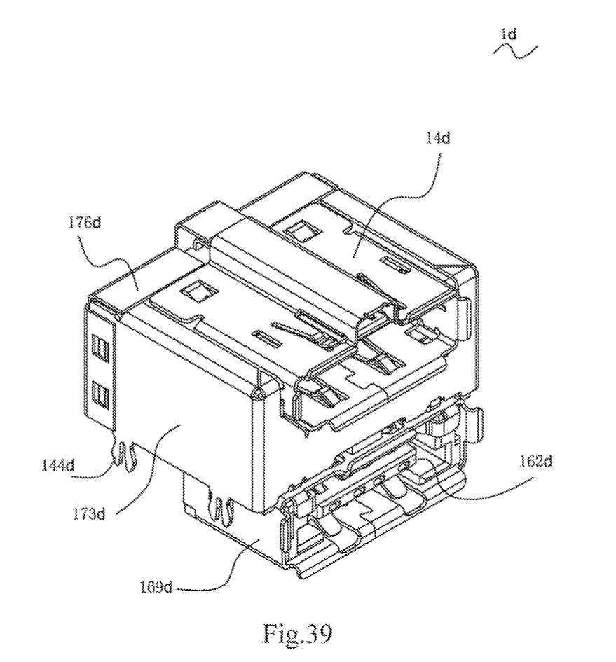

A fifth embodiment of the receptacle electrical connector is shown in FIGS. 39-45 and comprises a HPDP (High Power Display Port) receptacle opening with power supply on the upper side, and an ESATA receptacle opening on the lower side. The receptacle electrical connector 1d comprises a first body 11d; a plurality of first terminals 12d, two second terminals 13d and a plurality of fifth terminals 167d mounted on the first body 11d; a first cage 14d, a third cage 169d, an outer cage 173d, and a rear cage 176d mounted on the first body 11d; a first retention element 15d mounted on a bottom of the rear end of the first body 11d; and a spacer element assembly 178d mounted among the terminals.

As shown in FIG. 41, the first body 11d comprises a first main body portion 111d, a first tongue 112d and a second tongue 113d extending forward from the first main body 111d, a supporting portion 177d extending forwardly from the first main body portion 111d, a third main body portion 161d extending downwardly from the supporting portion 177d, and a third tongue 162d extending forwardly from the third main body portion 161d. The first main body portion 111d has a clasp portion 1119d protruding upward from the top thereof. The supporting portion 177d comprises two opposite side walls 1772d and a partition wall 1773d connected between the bottoms of the two side walls 1772d.

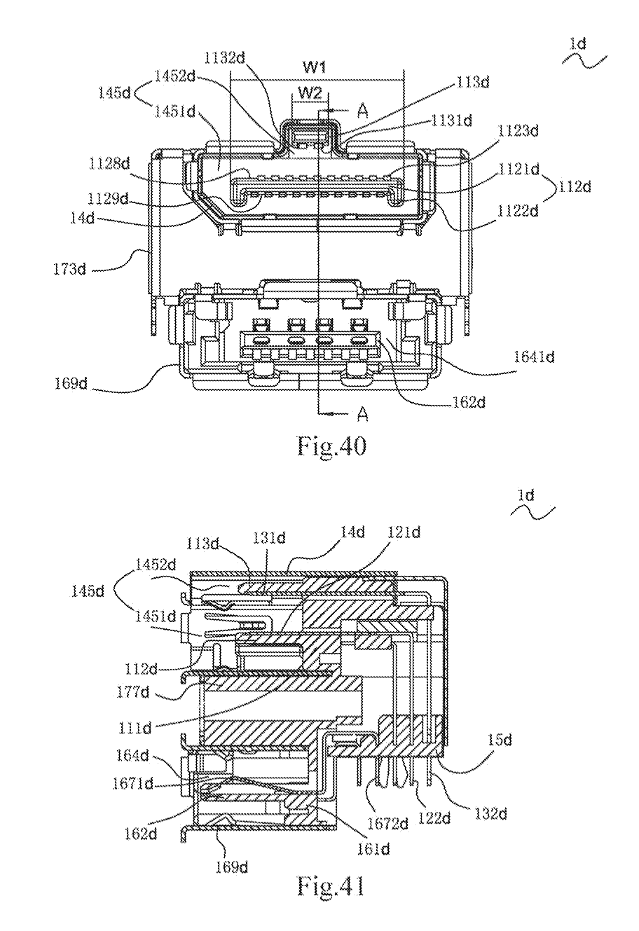

As shown in FIG. 40, the first tongue 112d comprises a base 1121d in a plate shape and two keying ribs 1122d protruding downward from left and right side edges of the base 1121d respectively. The base 1121d of the first tongue 112d comprises a first surface 1128d and a second surface 1129d opposite with each other. The first surface 1128d is configured to face upward and the second surface 1129d is configured to face downward. Each of the first and second surfaces 1128d and 1129d is provided with a plurality of first receiving slots 1123d. The first tongue 112d can be mated with a standard DP (Display Port) type plug electrical connector.

The first and second tongue 112d and 113d are configured to be parallel with each other and arranged in an upper and lower relationship. The first tongue 112d has a width W1 larger than that W2 of the second tongue 113d. Two second receiving slots 1131d, 1132d are provided in the lower surface of the second tongue 113d.

A plurality of fifth receiving slots 1621d are provided in at least one surface of the third tongue 162d. In the present embodiment, the third tongue 162d can be mated with the standard ESATA plug electrical connector.

As shown in FIGS. 40 and 41, the first terminals 12d can be divided into upper and lower rows. Each of the first terminals 12d has a mating portion 121d in a plate shape and a soldering portion 122d. The mating portions 121d of the first terminals 12d are provided in first receiving slots 1123d of the first tongue 112d, for transmitting high definition video signals. The mating portions 121d of the first terminals 12d located on the upper surface 1128d of the first tongue 112d are offset relative to those on the lower surface 1129d of the first tongue 112d, that is, the mating portions 121d in the upper row are not faced or aligned with those in the lower row.

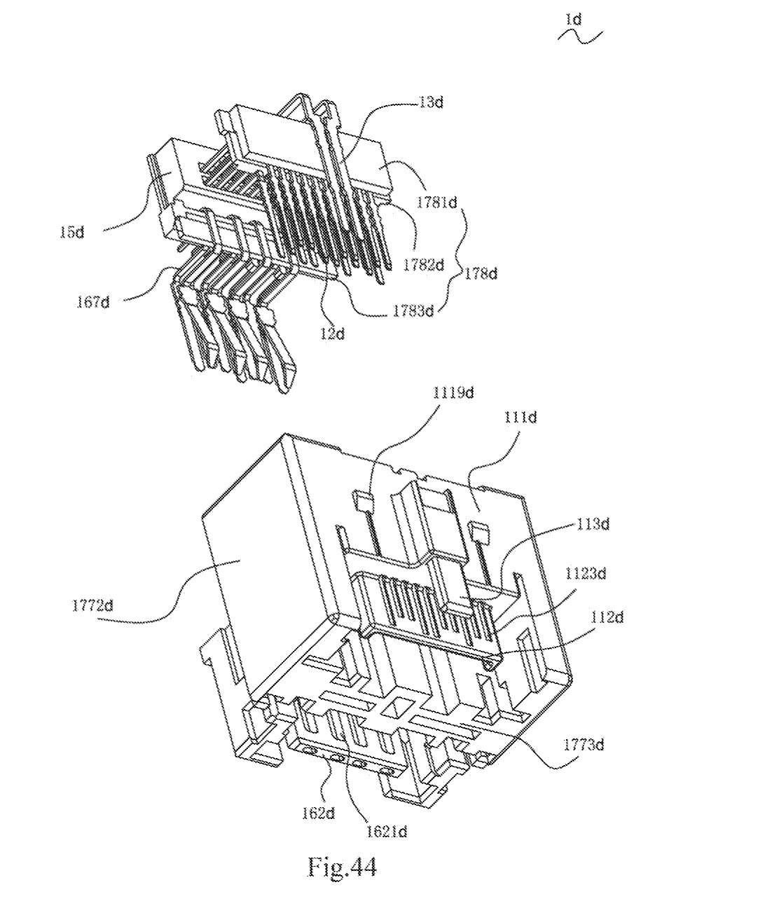

Please also see FIG. 44, each of the second terminals 13d comprises a mating portion 131d in a plate shape and a soldering portion 132d. One second terminal 13d is used to connect with the negative pole of the power source, and the other second terminal 13d is used to connect with the positive pole of the power source. A distal of the mating portion 131d of the one second terminal 13d connected to the negative pole of the power source is located at a position closer to the front compared with a distal of the mating portion 131d of the other second terminal 13d connected to the positive pole of the power source. The two second terminals 13d are used to transmit the power required by the display device, so as to save one separate power cable of the display device. In addition, the distance between the two soldering portions 132d is larger than that between the two mating portions 131d of the two second terminals 13d.

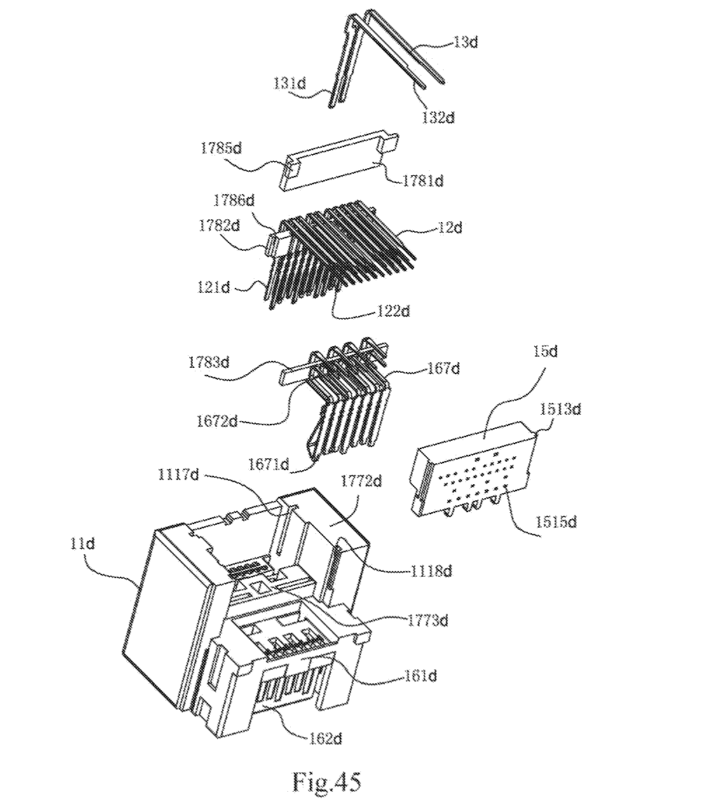

As shown in FIG. 45, the fifth terminals 167d are divided into upper and lower rows. Each of the fifth terminals 167d comprises a mating portion 1671d and a soldering portion 1672d. The mating portions 1671d of the upper row of fifth terminals 167d are elastic and have an arc shape, the mating portions 1671d of the lower row of fifth terminals 167d have a plate shape.

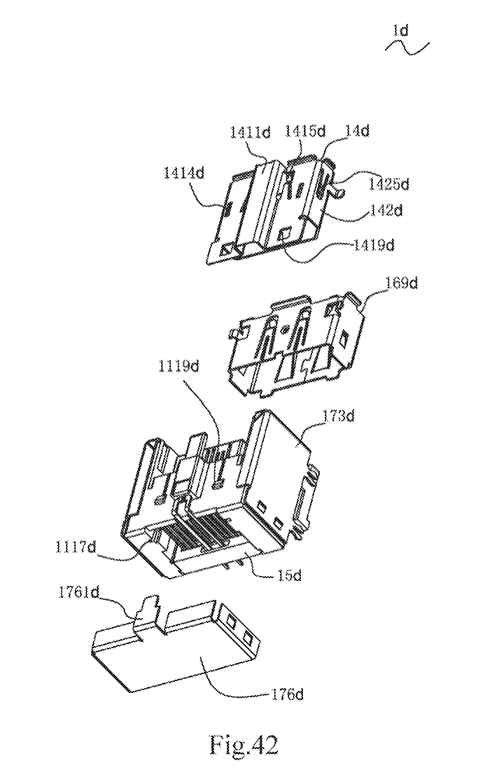

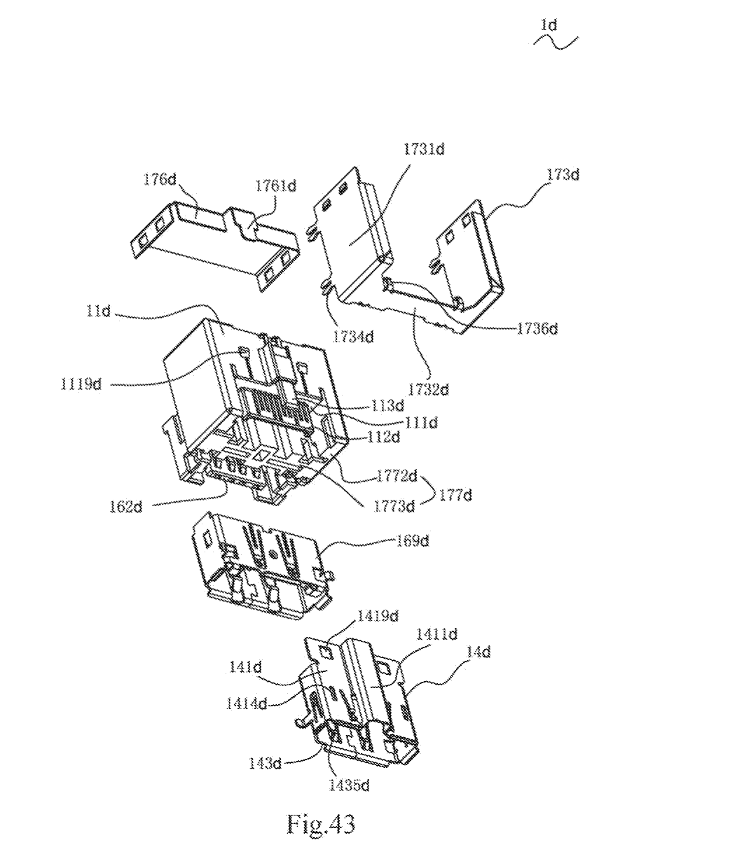

As shown in FIG. 40, the first cage 14d encloses the first and second tongue 112d and 113d to form a first receiving chamber 145d. A first mating chamber 1451d enclosing the first tongue 112d is formed around the first tongue 112d, in which a standard DP plug can be inserted. A second mating chamber 1452d enclosing the second tongue 113d is formed around the second tongue 113d. The first mating chamber 1451d has a width larger than that of the second mating chamber 1452d. The first and second mating chambers 1451d and 1452d are stacked and communicated with each other to form the first receiving chamber 145d. In details, as shown in FIGS. 42 and 43, the first cage 14d is formed by pressing a metal plate and has a shape with a small upper portion and a larger lower portion. The first cage 14d comprises a top plate 141d, two side plates 142d bending and extending downward from left and right sides of the top plate 141d, a bottom plate 143d formed by horizontally bending and extending the two side plates 142d toward each other and then engaging with each other. An arching portion 1411d in an invert U shape extends upward from a middle of the top plate 141d. The top plate 141d is provided with a mounting portion 1419d corresponding to the clasp portion 1119d in the body 11d at the rear end of the top plate, such that the first cage 14d can be fixed on the first body 11d. The top plate 141d is provided with a hole 1414d on each of left and right sides of the arching portion 1411d. The top plate 141d is also provided with a flexible clasp arm 1415d extending from rear to front on each left and right sides of the arching portion 1411d. The bottom plate 143d is provided with a flexible clasp arm 1435d extending from rear to front on each of the left and right portions thereof. Each of the two side plates 142d is provided with a flexible clasp arm 1425d extending from front to rear. Those elastic arms 1415d, 1425d, 1435d can be clasped on the different sides and positions in different depths of the plug electrical connector to improve the engaging strength.

As shown in FIGS. 40 and 41, the third cage 169d encloses the third tongue 162d to form a third receiving chamber 164d. The third receiving chamber 164d comprises a fifth mating chamber 1641d enclosing the third tongue 162d for inserting a standard ESATA plug into the fifth mating chamber 1641d.

The outer cage 173d is mounted on the two side walls 1772d and a partition wall 1773d of the supporting portion 177d, and comprises two opposite side plates 1731d, a front plate 1732d connected the lower portions of the front ends of the two side plates 1731d and a plurality of fixing foots 1734d extending downward from the two side plates 1731d. The two side plates 1731d cover the outer of the two side walls 1772d of the supporting portion 177d, and the front plate 1732d covers the front end of the partition wall 1773d of the supporting portion 177d. Two clasp arms 1736d is bending and extending backwardly from the upper and lower sides of the front plate 1732d respectively, so as to clasp the front end of the partition wall 1773d of the supporting portion 177d. In addition, the two upper clasp arms 1736d can abut against the bottom plate 143d of the first cage 14d located above the supporting portion 177d, and the two lower clasp arms 1736d can abut against the top portion of the third cage 169d located below the supporting portion 177d. Therefore, the three cages 14d, 169d, 173d can be electrically connected together, and then connected with the grounded circuit on the circuit board (not shown) via fixing foots 1734d, so as to realize the grounding of the three cages 14d, 169d, 173d.

As shown in FIG. 43, the back cage 176d clasps the rear end of the out cage 173d, in which the rear ends of the first terminals 12d, the second terminals 13d and the fifth terminals 167 are received. The back cage 176d is provided with a brim 1761d on the top end thereof. The front end of the brim 1761d is joined with the rear end of the arching portion 1411d of the first cage 14d, so as to cover the two second terminals 13d.

As shown in FIG. 44, the spacer element assembly 178d comprises a first spacer element 1781d, a second spacer element 1782d and a third spacer element 1783d. The first spacer element 1781d is provided between the second terminals 13d and the upper row of first terminals 12d, the second spacer element 1782d is provided between the two rows of first terminals 12d, the third spacer element 1783d is provided between the two rows of fifth terminals 167d. The first spacer element 1781d is provided with a flange 1785d on each of left and right sides thereof, and the second spacer element 1782d is also provided with a flange 1786d on each of left and right sides thereof. Those flanges 1785d, 1786d are mounted into a sliding groove 1117d located on the rear end of the first body 11d.

The first retention element 15d is mated with the first terminals 12d, the second terminals 13d and the fifth terminals 167d, so as to prevent the soldering portions of those terminals from bending. In details, as shown in FIG. 45, the first retention element 15d is provided with a plurality of perforations 1515d for inserting the soldering portions of the first terminals 12d, the second terminals 13d and the fifth terminals 167d. The first retention element 15d is also provided with a holding portion 1513d on each side thereof, to be fixed on the mounting portion 1118d on the rear end of the first body 11d.

The assembly procedure of the receptacle electrical connector 1d is as follows: inserting the above terminals 12d, 13d, 167d and the above spacer elements 1781d, 1782d, 1783d into the first body 11d in a direction of from rear to front; and aligning the first retention element 15d with the soldering portions 122d, 132d, 1672d of those terminals and inserting the first retention element 15d into the mounting portion 1118d of the first body 11d in a direction of from lower to upper; inserting the outer cage 173d into the first body 11d in a direction of from front to rear, and then fixing the back cage 176d on the rear end of the outer cage 173d, and finally inserting the first cage 14d and the third cage 169d onto the first body 11d in a direction of from front to rear.

As compared with the conventional connector, the receptacle electrical connector 1d in accordance with the third embodiment has the following advantageous effect: the structure strength of the first cage 14d can be enhanced to avoid breaking and distortion by the supporting portion 177d extending from the first body 11d and supporting the bottom and two sides of the first cage 14d. In addition, another receptacle opening is added to provide a connector with more function by providing the third main body portion 161d, the third tongue 162d, the fifth terminals 167d and the third cage 169d.

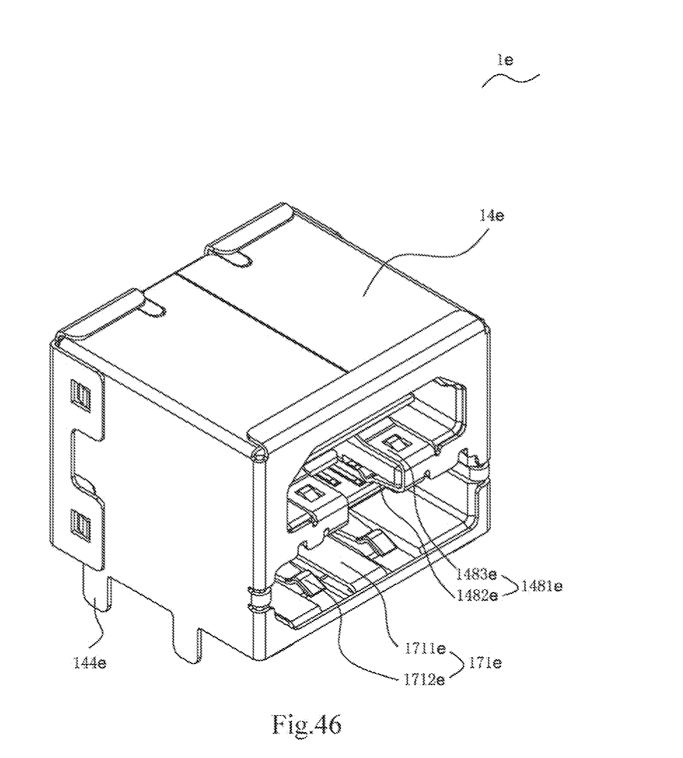

A sixth embodiment of the receptacle electrical connector is shown in FIGS. 46-51 and comprises a HPDP (High Power Display Port) receptacle opening with power supply, and an HDMI receptacle opening with power supply. The two receptacle openings are partly overlapped, so as to share power transmission.

The receptacle electrical connector 1e comprises a first body 11e; a plurality of first terminals 12e, two second terminals 13e and a plurality of fifth terminals 167e mounted on the first body 11e; two elastic clasp elements 171e and two holding portions 172e mounted on the first body 11e; a first cage 14e mounted on the first body 11e; and a first retention element 15e mounted on a bottom of the rear end of the first body 11d.

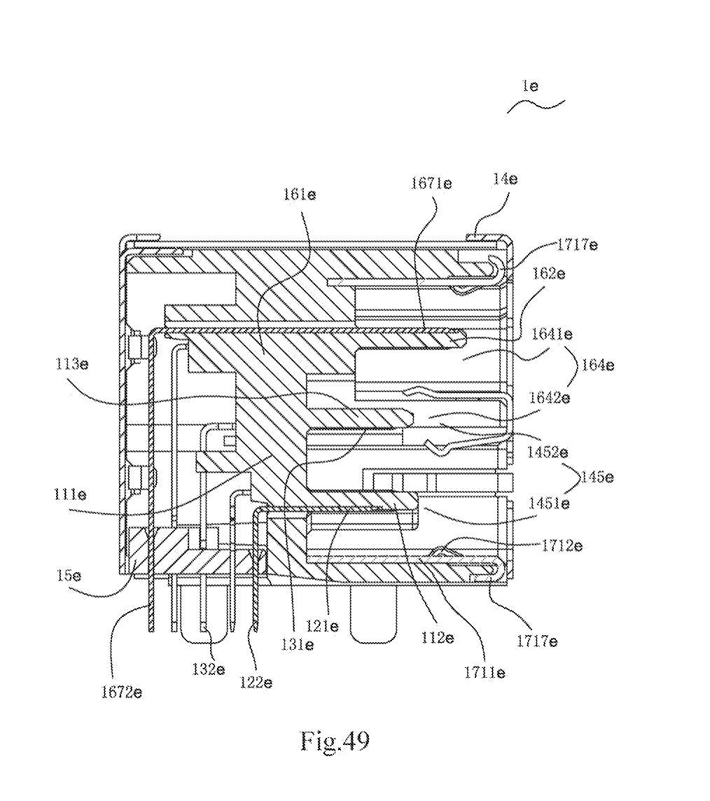

As shown in FIG. 49, the first body 11e comprises a first main body portion 111e; a first tongue 112e and a second tongue 113e extending forward from the first main body 111e; a third main body portion 161e extending upwardly from the first main body portion 111e; and a third tongue 162e extending forwardly from the third main body portion 161e.

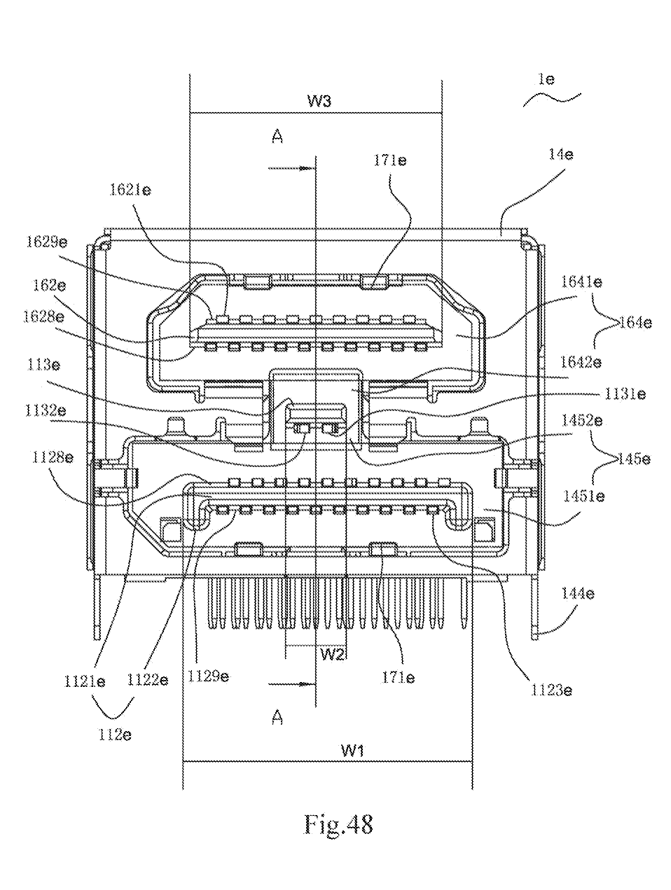

As shown in FIG. 48, the first body 11e is provided with a first receiving chamber 145e recessed therein. The first receiving chamber 145e has a shape with a small upper portion and a large lower portion, and comprises a first mating chamber 1451e and a second mating chamber 1452e stacked and communicated with each other in an upper and lower direction. The firs tongue 112e is located within the first mating chamber 1451e in which a standard DP (Display Port) is inserted. The second tongue 113e is located within the second mating chamber 1452e. The second mating chamber 1452e is located above the first mating chamber 1451e and has a much smaller width than that of the first mating chamber 1451e.

Similarly, the first body 11e is provided with a third receiving chamber 164e recessed therein. The third receiving chamber 164e has a shape with a large upper portion and a small lower portion, and comprises a fifth mating chamber 1641e and a sixth mating chamber 1642e stacked and communicated with each other in an upper and lower direction. The third tongue 162e is located within the fifth mating chamber 1641e in which a standard HDMI plug can be inserted. The inserted depth of the fifth mating chamber 1641e is different from that of the first mating chamber 1451e. The second tongue 113e is located within the sixth mating chamber 1642e. The sixth mating chamber 1642e is located under the fifth mating chamber 1641e, and has a much smaller width than that of the fifth mating chamber 1641e. The sixth mating chamber 1642e is overlapped with the second mating chamber 1452e around the second tongue 113e, such that the third receiving chamber 164e is partly overlapped with the first receiving chamber 145e to share the second tongue 113e.

The first tongue 112e comprises a base 1121e in a plate shape and two keying ribs 1122e protruding downwardly from left and right side edges of the base 1121e respectively. The base 1121e of the first tongue 112e comprises a first surface 1128e and a second surface 1129e opposite with each other. The first surface 1128e is configured to face upward and the second surface 1129e is configured to face downward. Each of the first and second surfaces 1128e and 1129e is provided with a plurality of first receiving slots 1123e. The first tongue 112e can be mated with a standard DP (Display Port) type plug electrical connector.

The first and second tongue 112e and 113e are configured to be parallel with each other and arranged in an upper and lower relationship. The first tongue 112e has a width W1 larger than that W2 of the second tongue 113e. Two second receiving slots 1131e, 1132e are provided in the lower surface of the second tongue 113e.

The third tongue 162e comprises a first surface 1628e and a second surface 1629e opposite with each other. The first surface 1628e is configured to face upward and the second surface 1629e is configured to face downward. Each of the first and second surfaces 1628e and 1629e is provided with a plurality of fifth receiving slots 1621e. The third tongue 162e can be mated with a standard HDMI type plug electrical connector.

Each of the first terminals 12e has a mating portion 121e in a plate shape and a soldering portion 122e. The mating portions 121e of the first terminals 12e are provided in first receiving slots 1123e of the first tongue 112e, for transmitting high definition video signals. The mating portions 121e of the first terminals 12e located on the upper surface 1128e of the first tongue 112e are offset relative to those on the lower surface 1129e of the first tongue 112e, that is, the mating portions 121e in an upper row are not faced or aligned with the mating portions 121e in a lower row.

Each of the second terminals 13e comprises a mating portion 131e in a plate shape and a soldering portion 132e. One second terminal 13e is used to connect with the negative pole of the power source, and the other terminal 13e is used to connect with the positive pole of the power source. A distal of the mating portion 131e of the one second terminal 13e connected to the negative pole of the power source is located at a position closer to the front compared with a distal of the mating portion 131e of the other second terminal 13e connected to the positive pole of the power source. The two second terminals 13e are used to transmit the power required by the display device, so as to save one separate power cable of the display device. In addition, the distance between the two soldering portions 132e is larger than that between the two mating portions 131e of the two second terminals 13e.

Each of the fifth terminals 167e comprises a mating portion 1671e in a plate shape and a soldering portion 1672e. The mating portions 1671e of the fifth terminals 167e are provided in the fifth receiving slots 1621e of the third tongue 162e, for transmitting high definition video signals. The mating portions 1671e of the first terminals 167e located on the upper surface 1628e of the third tongue 162e are offset relative to those on the lower surface 1629e of the third tongue 162e, such that the distance between the mating portions 1671e of the upper row of fifth terminals 167e and those of the lower row of fifth terminals 167e can be increased, thereby the signal interference during the high frequency data transmission can be reduced to improve the signal transmission quality.

The two elastic clasp elements 171e are mounted on the bottom of the first receiving chamber 145e and the top of the third receiving chamber 164e respectively. Each of the elastic clasp elements 171e has a mounting portion 1711e and two flexible clasp arms 1712e mounted on the first body 11e. In details, the mounting portion 1711e comprises a locking unit 1715e and two clasping units 1716e. The locking unit 1715e has a hook 1717e on its front end for clasping the groove 1117e in the first body 11e, and the clasping units 1716e are arranged on the rear end of the flexible clasp arms 1712e and have clasping portions 1718e for being inserted into the first body 11e.

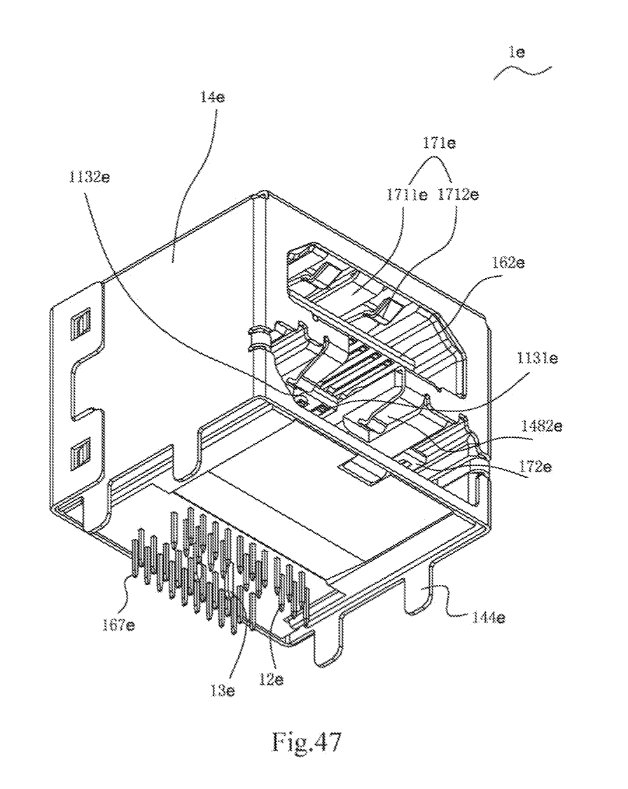

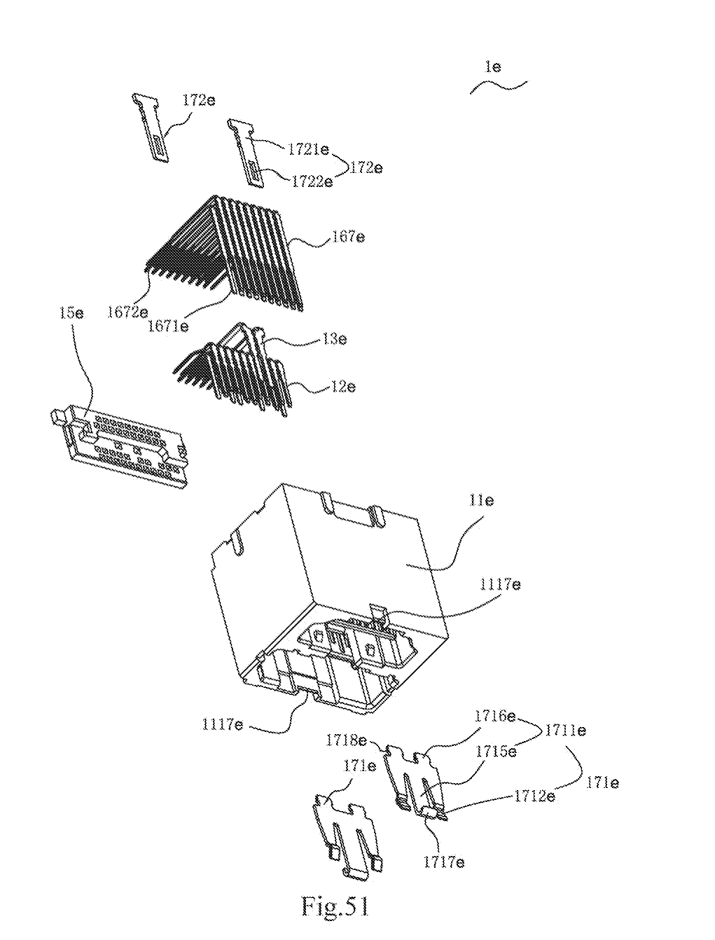

The two holding portions 172e are mounted on the top of the first mating chamber 1451e in the first receiving 145e (please see FIGS. 47 and 51). Each of the holding portions 172e is provided with a holding portion 1721e on its rear end for being fixed onto the first body 11e, and each of the holding portions 172e is provided with a holding hole 1722e on its front end for fitting with the hooks in the mating electrical connector.

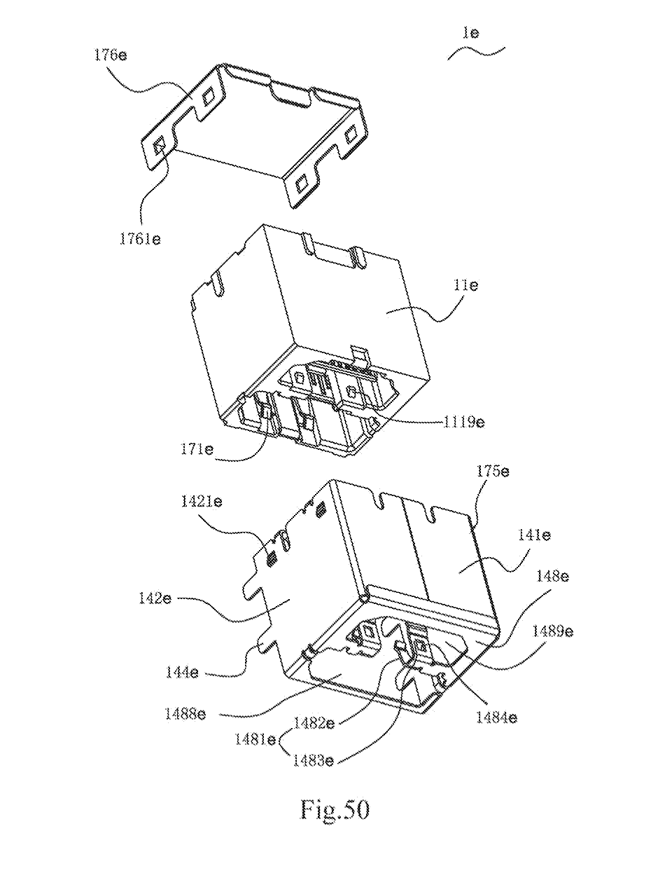

As shown in FIG. 50, the first cage 14e is formed by pressing a metal plate and formed by a front shielding element 175e and a rear shielding element 175e clasped with each other. The first cage 14e is mounted on the periphery of the first body 11e and encloses the first tongue 112e, the second tongue 113e and the third tongue 162e of the first body 11e to achieve electromagnetic shielding. The first cage 14e comprises a top plate 141e, two side plates 142e bending and extending downward from left and right sides of the top plate 141e, a front plate 148e connected to the front ends of the two side plates 142e; and four fixing foots 144e protruding downwardly from the two side plates 142. The two side plates 142 are provided with a buckle portion 1421e on its rear end for buckling on the buckle portion 1761e of the rear shielding element 176e. The front plate 148e is provided with a first opening 1488e and a third opening 1489e which are communicated with each other and corresponding with the first receiving chamber 145e and the third receiving chamber 164e respectively. The middle of the front plate 148e is provided with two U-shaped portions 1481e extending toward the inner of the first and third receiving chambers 145e and 164e. Each of the U-shaped portions 1481e has two flexible clasp arms 1482e, 1483e extending inwardly in a direction of from front to rear from the top of the first receiving chamber 145e and the bottom of the third receiving chamber 164e respectively. Each side plate 142e is provided with two flexible clasp arm 1425e extending and bending inwardly in a direction of from front to rear from the first opening 1488e at the side of the first receiving chamber 145e. Those flexible clasp arms 1712e, 1482e, 1483e, 1425e can be clasped on the different sides and positions in different depths of the plug electrical connector in the first receiving chamber 145e/the third receiving chamber 164e to improve the engaging strength.

The first retention element 15e is mated with the soldering portions of the first terminals 12e, the second terminals 13e and the fifth terminals 167e, so as to prevent the terminals from bending and shorting out.

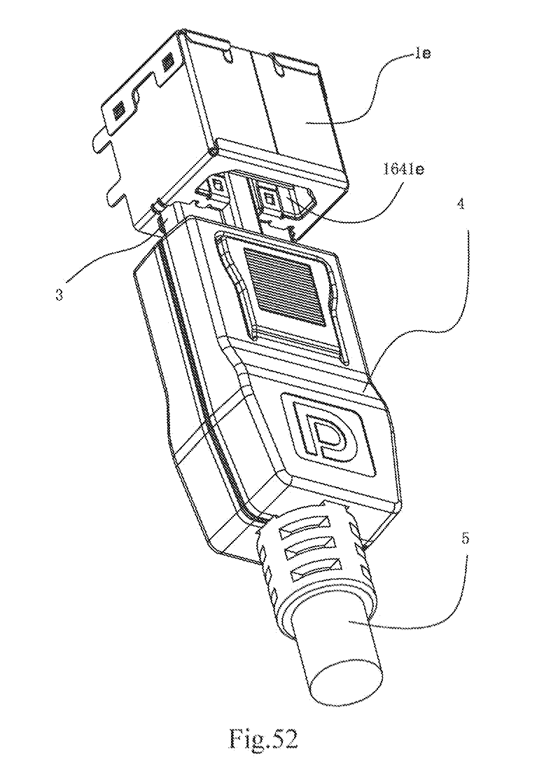

As shown in FIG. 52, the first cable connector with power supply and satisfied the DP signal transmission standard can be inserted into the first receiving chamber 145e of the receptacle electrical connector 1e. The first cable connector comprises a first plug electrical connector 3 (i.e. the plug electrical connector in the first embodiment), an insulated housing 4 and a cable 5 connected with the first plug electrical connector 3. At this time, the fifth mating chamber 1461e in the third receiving chamber 164e is available and the sixth mating chamber 1462 is occupied.

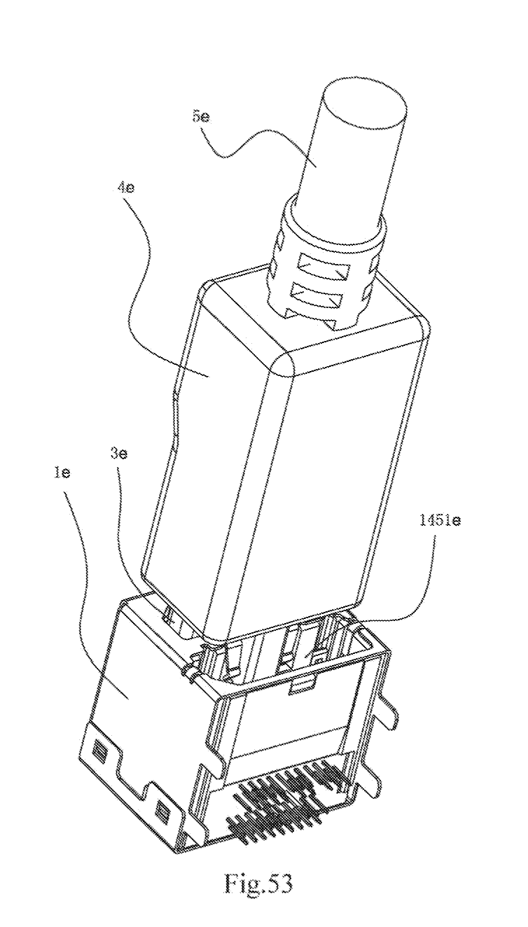

As shown in FIGS. 53-57, the second cable connector with power supply and satisfied the HDMI signal transmission standard can be inserted into the third receiving chamber 164e of the receptacle electrical connector 1e. The second cable connector comprises a second plug electrical connector 3e (i.e. the plug electrical connector in the second embodiment), an insulated housing 4e and a cable 5e connected with the second plug electrical connector 3e. At this time, the first mating chamber 1451e in the first receiving chamber 145e is available and the second mating chamber 1452e is occupied.

The second plug electrical connector 3e comprises a second body 31e, a plurality of third terminals 32e mounted on the second body 31e and two fourth terminals 33e for transmitting power and a second cage 34e.

The second body 31e comprises a second main body portion 311e and a second protrusion 312e protruding from the top of the second main body portion 311e. The second main body portion 311e is provided with a third mating chamber 317e at its middle. The third mating chamber 317e is provided with a plurality of third receiving slots 3111e on its upper and lower sides, and the second protrusion 312e is provided with two fourth receiving slots 3124e on its lower surface.

A plurality of third terminals 32e are arranged into the plurality of third receiving slots 3111e respectively. Each of third terminals 32e comprises a mating portion 321e and a soldering portion (not shown in FIGs). The mating portions 321e are elastic protrusions. The mating portions 321e of the third terminals 32e located on the upper side of the third mating chamber 317e are offset relative to those on the lower side of the third mating chamber 317e.

Two fourth terminals 33e for transmitting power are arranged into two fourth receiving slots 3124e respectively. Each of the fourth terminals 33e comprises a mating portion 331e and a soldering portion (not shown in FIGs). The mating portions 331e are elastic protrusions.

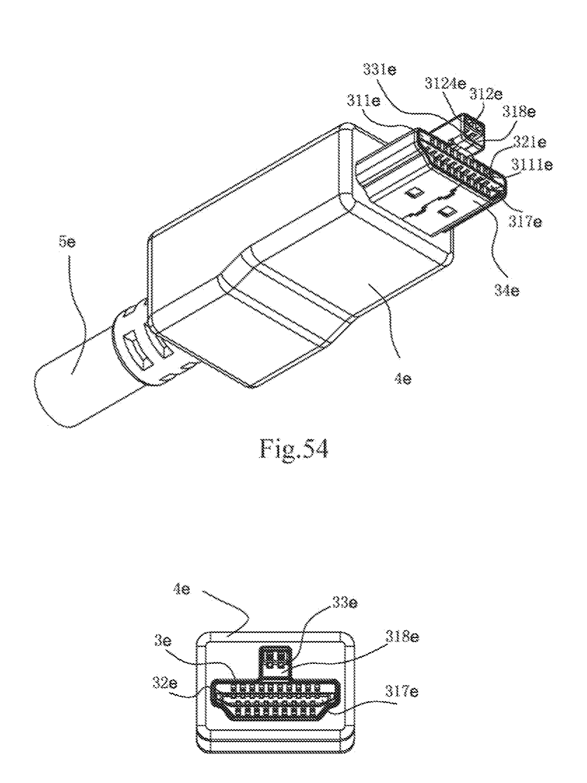

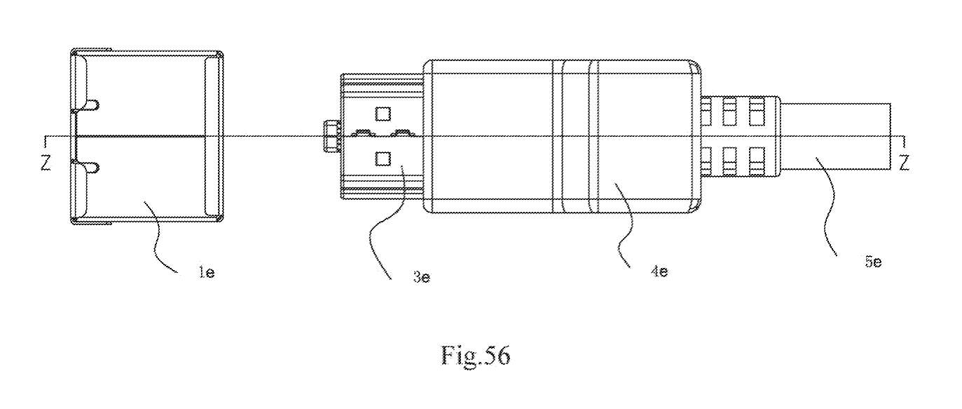

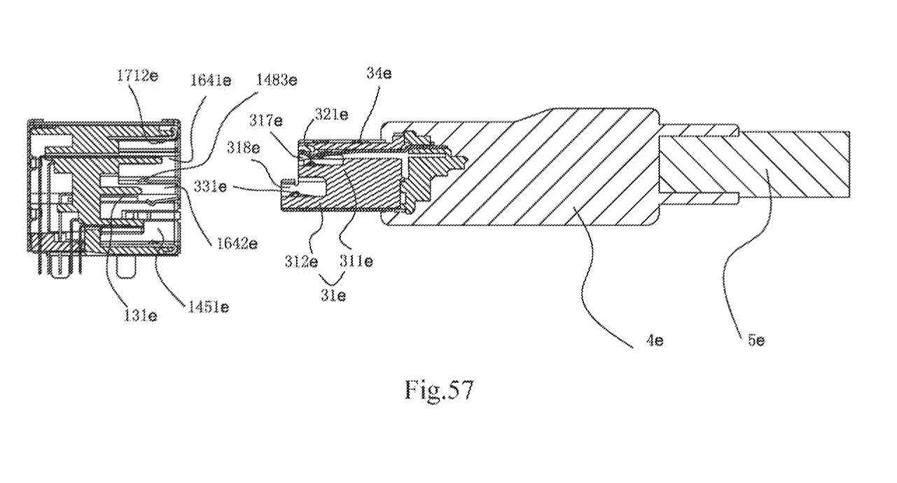

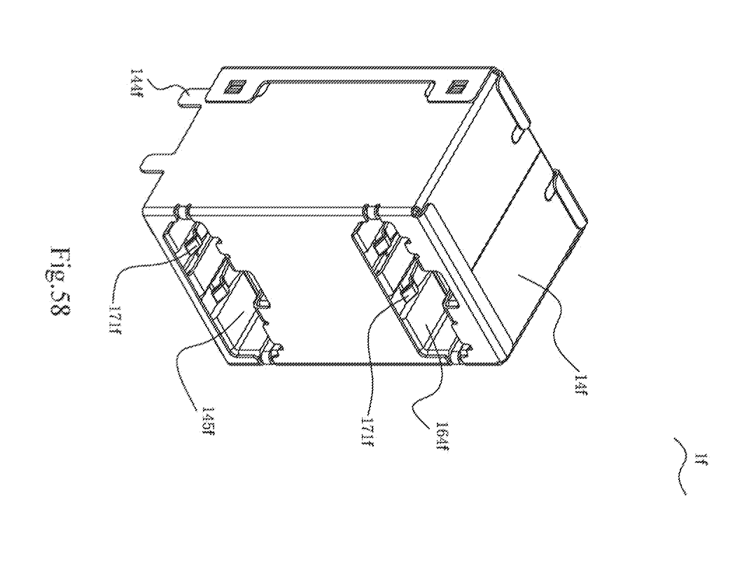

The second cage 34e encloses the periphery of the second body 31e and is formed with a fourth mating chamber 318e together with the second protrusion 312e. The mating portions 331e of the fourth terminals 33e are protruded downwardly toward the fourth mating chamber 318e from the fourth receiving slots 3124e. The front edge of the fourth mating chamber 318e is protruded forwardly relative to the front edge of the third mating chamber 317e (please see FIGS. 54 and 56), such that the fourth mating chamber 318e can be mated with the second tongue 113e located at a deeper position in the receptacle electrical connector le.

The fourth cage 34e elastically abuts against the flexible clasp arms 1712e of the elastic clasp element 171e and the flexible clasp arm 1483e of the U-shaped portion 1481e of the first cage 14e, and the mating portions of the third terminals 32e and the fourth terminals 33e elastically abut against the mating portions 13e of the fifth terminals 167e and the second terminals 13e, when the second cable connector is inserted into the third receiving chamber 164e in the receptacle electrical connector le.

The assembly procedure of the receptacle electrical connector 1e is as follows: inserting the first terminals 12e, the second terminals 13e and the fifth terminals 167e into the first body 11e in a direction of from rear to front; and aligning the first retention element 15e with the soldering portions of those terminals 12e, 13e, 167e and inserting the first retention element 15e in a direction of from lower to upper; inserting the two holding portions 172e into the first body 11e in a direction of from rear to front, and then inserting the two elastic elements 171e into the first body 11e in a direction of from front to rear; and finally mounting the front shielding element 175e and the rear shielding element 176e into the first body 11e.

As compared with the conventional connector, the receptacle electrical connector 1e and the plug electrical connector 3e (the second embodiment of the plug electrical connector) in accordance with the sixth embodiment has the following advantageous effects: the first receiving chamber 145e and the third receiving chamber 164e are recessed from the first body 11e, and the power supplying portions of the first and second receiving chambers are overlapped, and thusly the receiving chambers as above have an improved strength, are not easily broken and deformed, and the second tongue 113 thereof can provide power to the plug electrical connector with two different kinds of transmission standard. The fourth mating chamber 318e can be suitably mated with the second tongue 113e located on the relative deep position in the receptacle electrical connector le, since the front edge of the fourth mating chamber 318e is protruded forwardly relative to that of the third mating chamber 317e.

A seventh embodiment of the receptacle electrical connector is shown in FIGS. 58-62 and comprises two stacked HPDP (High Power Display Port) receptacle openings with additional power supply. As shown in FIG. 62, the receptacle electrical connector if comprises a first body 11f; a plurality of first terminals 12f, two second terminals 13f, a plurality of fifth terminals 167f and two sixth terminals 168f mounted on the first body 11f; two elastic clasp elements 171f and four holding portions 172f mounted on the first body 11f; a first cage 14f mounted on the first body 11f; and a first retention element 15f mounted on a bottom of the rear end of the first body 11f.

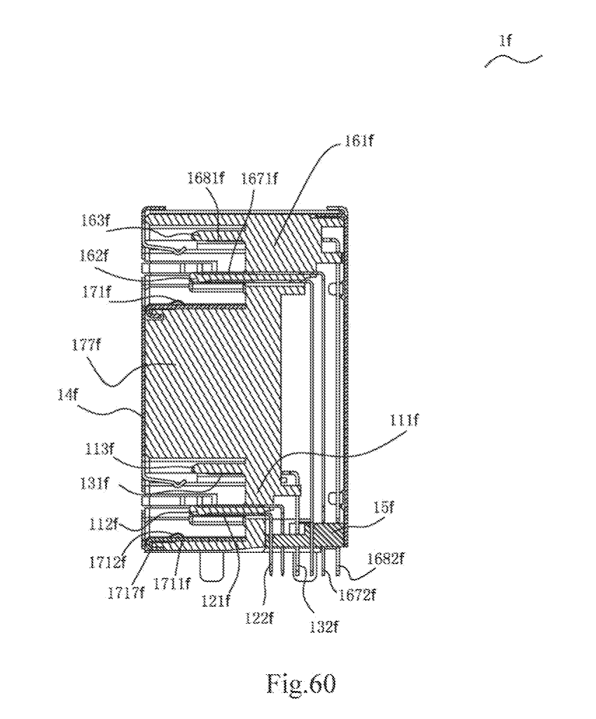

As shown in FIG. 60, the first body 11f comprises a first main body portion 111f; a first tongue 112f and a second tongue 113f extending forward from the first main body 111f; a third main body portion 161f extending upwardly from the first main body portion 111f (in the other embodiment, the third main body portion may horizontally extend or downwardly extend from the first main body portion); a third tongue 162f and a fourth tong 163f extending forwardly from the third main body portion 161f; and a spacer portion 177f located between the first main body portion 111f and the third main body portion 161f.

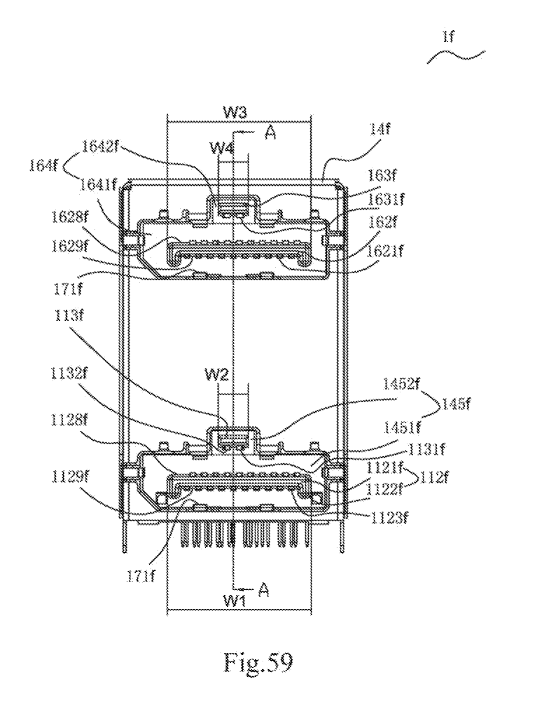

Please also see FIG. 59, the first body 11f is provided with a first receiving chamber 145e recessed therein. The first receiving chamber 145f (HPDP interface) has a shape with a small upper portion and a large lower portion, and comprises a first mating chamber 1451f and a second mating chamber 1452f stacked and communicated with each other in an upper and lower direction. The first tongue 112f is located within the first mating chamber 1451f in which a standard DP (Display Port) is inserted. The first tongue 112f comprises a base 1121f in a plate shape and two keying ribs 1122f protruding downwardly from left and right side edges of the base 1121f respectively. The second tongue 113f is located within the second mating chamber 1452f. The second mating chamber 1452f is located above the first mating chamber 1451f and has a much smaller width than that of the first mating chamber 1451f.

Similarly, the first body 11f is provided with a third receiving chamber 164f recessed therein. The third receiving chamber 164f (also is HPDP interface) has an shape with a small upper portion and a large lower portion, and comprises a fifth mating chamber 1641f and a sixth mating chamber 1642f stacked and communicated with each other in an upper and lower direction. The third tongue 162f is located within the fifth mating chamber 1641f in which a standard DP plug can be inserted. The fourth tongue 163f is located within the sixth mating chamber 1642f. The sixth mating chamber 1642f is located above the fifth mating chamber 1641f, and has a much smaller width than that of the fifth mating chamber 1641f. The third receiving chamber 164f is separated from the first receiving chamber 145f by the spacer portion 177f.

The base 1121f of the first tongue 112f comprises a first surface 1128f and a second surface 1129f opposite with each other. The first surface 1128f is configured to face upward and the second surface 1129f is configured to face downward. Each of the first and second surfaces 1128f and 1129f is provided with a plurality of first receiving slots 1123f.

The first and second tongue 112f and 113f are configured to be parallel with each other and arranged in an upper and lower relationship. The first tongue 112f has a width W1 larger than that W2 of the second tongue 113f. Two second receiving slots 1131f, 1132f are provided in the lower surface of the second tongue 113f.

Similarly to the first and second tongues 112f and 113f, the third tongue 162f also comprises a first surface 1628f and a second surface 1629f opposite with each other. Each of the first and second surfaces 1628f and 1629f is provided with a plurality of fifth receiving slots 1621f. The third tongue 162f can be mated with a standard DP type plug electrical connector.

The fourth and third tongue 163f and 162f are configured to be parallel with each other and arranged in an upper and lower relationship. The third tongue 162f has a width W3 larger than that W4 of the fourth tongue 163f. Two sixth receiving slots 1631f are provided in the lower surface of the fourth tongue 163f.

Each of the first terminals 12f has a mating portion 121f in a plate shape and a soldering portion 122f. The mating portions 121f of the first terminals 12f are received in first receiving slots 1123f of the first tongue 112f, for transmitting high definition video signals. The mating portions 121f of the first terminals 12f located on the upper surface 1128f of the first tongue 112f are offset relative to those on the lower surface 1129f of the first tongue 112f, that is, the mating portions 121f in an upper row are not faced or aligned with those in a lower row.

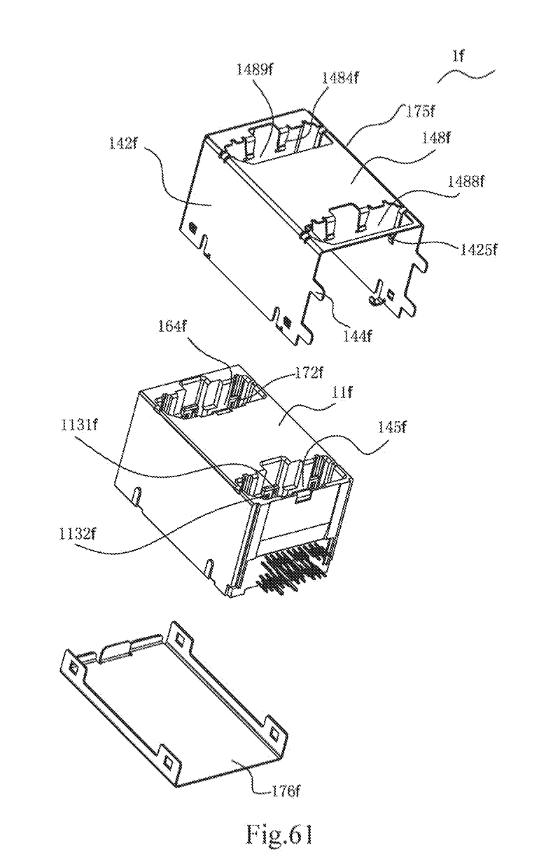

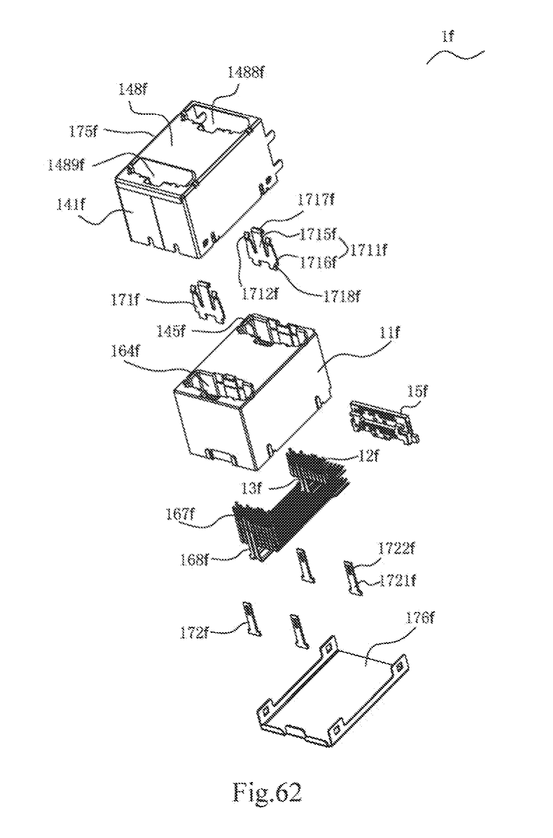

Referring to FIGS. 61 and 62, each of the second terminals 13f comprises a mating portion 131f in a plate shape and a soldering portion 132f. One second terminal 13f received in one second receiving slot 1131f is used to connect with the negative pole of the power source, and the other second terminal 13f received into the other second receiving slot 1132f is used to connect with the positive pole of the power source. A distal of the mating portion 131f of the one second terminals 13f connected to the negative pole of the power source is located at a position closer to the front of the second tongue 113f, compared with a distal of the mating portion 131f of the other second terminals 13f connected to the positive pole of the power source. The two second terminals 13f are used to transmit the power required by the display device, so as to save one separate power cable of the display device. In addition, the distance between the two soldering portions 132f is larger than that between the two mating portions 131f of the two second terminals 13f.

As shown in FIG. 60, each of the fifth terminals 167f has the similar structure and function as compared with the first terminals 12f, and comprises a mating portion 1671f in a plate shape and a soldering portion 1672f. The mating portions 1671f of the fifth terminals 167f are received in the fifth receiving slots 1621f of the third tongue 162f, for transmitting high definition video signals. The mating portions 1671f of the first terminals 167f located on the upper surface 1628f of the third tongue 162f are offset relative to those on the lower surface 1629f of the third tongue 162f in an upper and lower direction, that is, the mating portions 1671f in an upper row are not faced or aligned with those in a lower row.

Each of the sixth terminals 168f has the similar structure and function as compared with the second terminals 13f, and comprises a mating portion 1681f in a plate shape and a soldering portion 1682f. One second terminal 168f is used to connect with the negative pole of the power source, and the other second terminal 168f is used to connect with the positive pole of the power source. A distal of the mating portion 1681f of the one sixth terminals 168f connected to the negative pole of the power source is located on a position closer to the front of the fourth tongue 163f, compared with a distal of the mating portion 1681f of the other sixth terminals 168f connected to the positive pole of the power source.

Referring to FIGS. 60 and 62, the two elastic clasp elements 171f are mounted on the bottoms of the first receiving chamber 145f and third receiving chamber 164f respectively. Each of the elastic clasp elements 171f has a mounting portion 1711f and two flexible clasp arms 1712f mounted on the first body 11f. In details, the mounting portion 1711f comprises a locking unit 1715f and two clasping units 1716f. The front end of the locking unit 1715f has a hook 1717f for clasping the first body 11f, and the rear end of the clasping units 1716f are provided with a clasping portion 1718f for being inserted into the first body 11f.

Referring to FIGS. 61 and 62, two holding portions 172f are mounted on the top of the first mating chamber 1451f in the first receiving chamber 145f, and two holding portions 172f are mounted on the top of the fifth mating chamber 1641f in the third receiving chamber 164f. Rear end of each holding portion 172f is provided with a holding portion 1721f for being fixed onto the first body 11f, and front end of each holding portion 172f is provided with a holding hole 1722f for fitting with the hooks (not shown in FIGs) in the mating electrical connector.

Referring to FIGS. 61 and 62, the first cage 14f is formed by pressing a metal plate and formed by a front shielding element 175f and a rear shielding element 176f clasped with each other. The front shielding element 175f comprises a top plate 141f, two side plates 142f bending and extending downward from left and right sides of the top plate 141f, a front plate 148f connected to the front ends of the top plate 141f and the two side plates 142f; and four fixing foots 144f protruding downwardly from the two side plates 142f. The front plate 148f is provided with a first opening 1488f and a second opening 1489f corresponding with the first receiving chamber 145f and the third receiving chamber 164f respectively. The front plate 148f is provided with two flexible clasp arms 1484f extending inwardly in a direction of from front to rear at the tops of the first receiving chamber 145f and the third receiving chamber 164f respectively. Each of two side plates 142f is provided with a flexible clasp arm 1425f extending and bending inwardly in a direction of from front to rear from the first opening 1488f at the side of the first receiving chamber 145f. The first cage 14f encloses the first tongue 112f, the second tongue 113f, the third tongue 162f and the fourth tongue 163f to achieve electromagnetic shielding.

Those flexible clasp arms 1712f, 1484f, 1425f can be clasped on the different sides and positions in different depths of the plug electrical connector in the first receiving chamber 145f/the third receiving chamber 164f to improve the engaging strength.

The first retention element 15f is mated with the first terminals 12f, the second terminals 13f, the fifth terminals 167f and the sixth terminals 168f, so as to prevent the soldering portions of the terminals from bending.

The assembly procedure of the receptacle electrical connector if is as follows: inserting the first terminals 12f, the second terminals 13f, the fifth terminals 167f and the sixth terminals 168f into the first body 11f in a direction of from rear to front; and aligning the first retention element 15f with the soldering portions of those terminals and inserting the first retention element 15f in a direction of from lower to upper; inserting the four holding portions 172f into the first body 11f in a direction of from rear to front, and then inserting the two elastic elements 171f into the first body 11f in a direction of from rear to front; and finally mounting the front shielding element 175f and the rear shielding element 176f into the first body 11f.

It should be noted that although one receptacle electrical connector 1 is provided with two HPDP receptacle openings in the above embodiment, the receptacle electrical connector 1 may be provided with one or three or more than three HPDP receptacle openings.

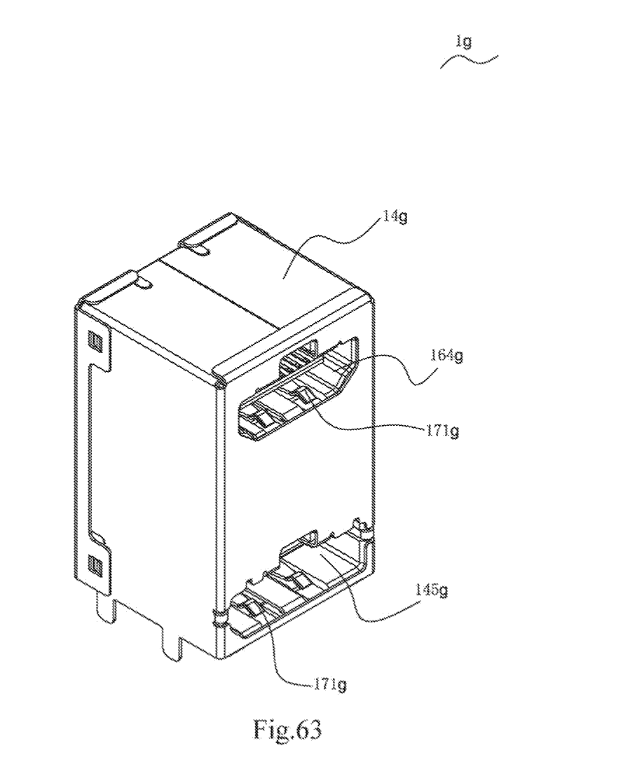

An eighth embodiment of the receptacle electrical connector 1g as shown in FIGs. 63-65 and comprises a first body 11g; a plurality of first terminals 12g, two second terminals 13g, a plurality of fifth terminals 167g and two sixth terminals 168g mounted on the first body 11g; two elastic clasp elements 171g and two holding elements mounted on the first body 11g; a first cage 14g covering the first body 11g; and a first retention element 15g mounted on a bottom of the rear end of the first body 11g.

The structure of the receptacle electrical connector 1g is generally similar to that of the above seventh embodiment except that there is an HDMI receptacle opening (corresponding to the third receiving chamber 164g) with additional power supply on the upper of the receptacle electrical connector 1g. The structure of the HPDP receptacle opening (corresponding to the first receiving chamber 145g) on the lower of the receptacle electrical connector 1g is the same as that mentioned in the above embodiment, and thusly the description thereof is omitted.

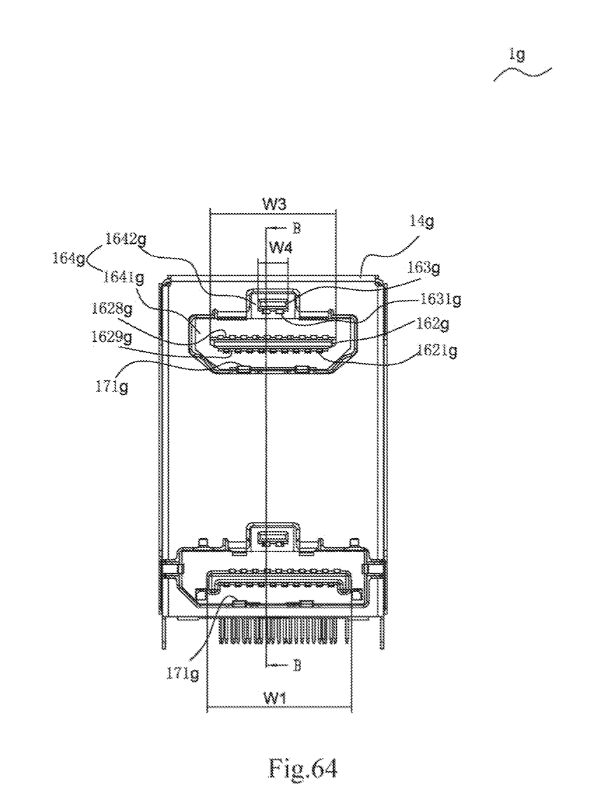

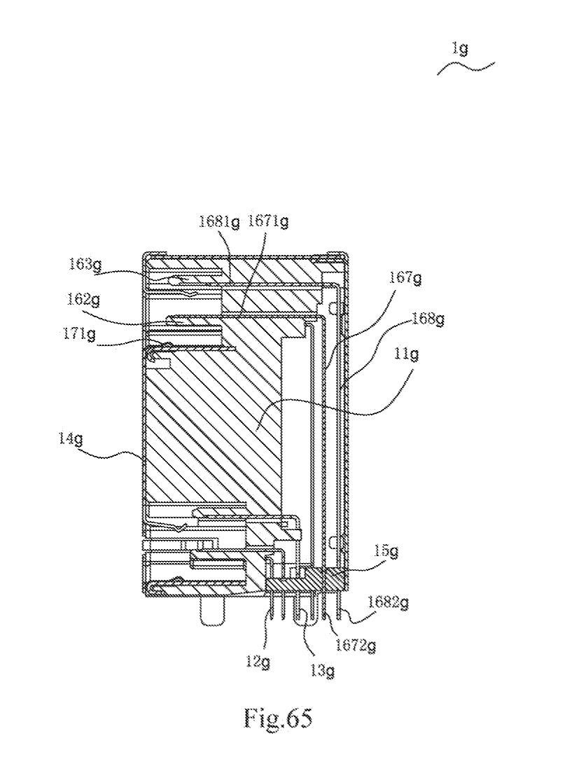

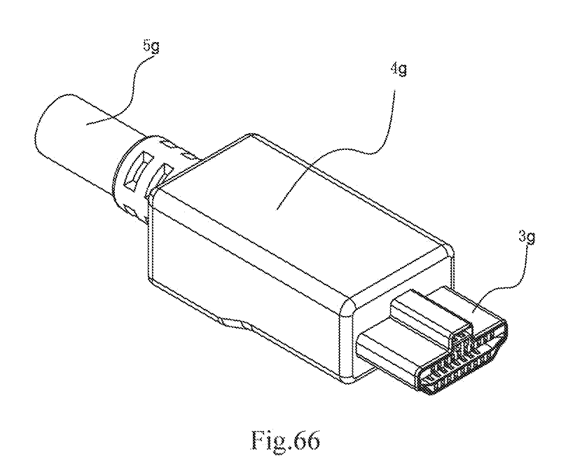

As shown in FIG. 64, the first body 11g is provided with a third receiving chamber 164g recessed therein. The third receiving chamber 164g has a shape with a small upper portion and a large lower portion, for receiving a third cable connector with an additional power supply and satisfied with the HDMI transport protocols (as shown in FIG. 66). The third receiving chamber 164g comprises a fifth mating chamber 1641g and a sixth mating chamber 1642g stacked and communicated with each other in an upper and lower direction. The third tongue 162g is located within the fifth mating chamber 1641g in which a standard HDMI type plug can be inserted. The fourth tongue 163g is located within the sixth mating chamber 1642g. The sixth mating chamber 1642g is located above the fifth mating chamber 1641g, and has a much smaller width than that of the fifth mating chamber 1641g. The third tongue 162g also comprises a first surface 1628g and a second surface 1629g opposite with each other. The first surface 1628g is configured to face upward and the second surface 1629g is configured to face downward. Each of the first and second surfaces 1628g and 1629g is provided with a plurality of fifth receiving slots 1621g. The third tongue 162g can be mated with a standard HDMI type plug electrical connector.

The fourth and third tongue 163g and 162g are configured to be parallel with each other and arranged in an upper and lower relationship. The third tongue 162g has a width W3 larger than that W4 of the fourth tongue 163g. Two sixth receiving slots 1631g are provided in the lower surface of the fourth tongue 163g.

Each of the fifth terminals 167g comprises a mating portion 1671g in a plate shape and a soldering portion 1672g. The mating portions 1671g of the fifth terminals 167g are received in the fifth receiving slots 1621g of the third tongue 162g in accordance with the HDMI interface standard, for transmitting high definition video signals. The mating portions 1671g of the first terminals 167g located on the upper surface 1628g of the third tongue 162g are offset relative to those on the lower surface 1629g of the third tongue 162g in an upper and lower direction.

Each of the sixth terminals 168g comprises a mating portion 1681g in a plate shape and a soldering portion 1682g. One second terminal 168g is used to connect with the negative pole of the power source, and the other is used to connect with the positive pole of the power source. The two second terminals 168g are used to transmit the power required by the display device, so as to save one separate power cable of the display device.

As shown in FIG. 63, the two elastic clasp elements 171g identical with the elastic clasp elements 171f are mounted on the bottoms of the first receiving chamber 145g and third receiving chamber 164g respectively.

The assembly procedure of the receptacle electrical connector 1g is similar as that of the receptacle electrical connector 1f, and the description thereof is omitted.

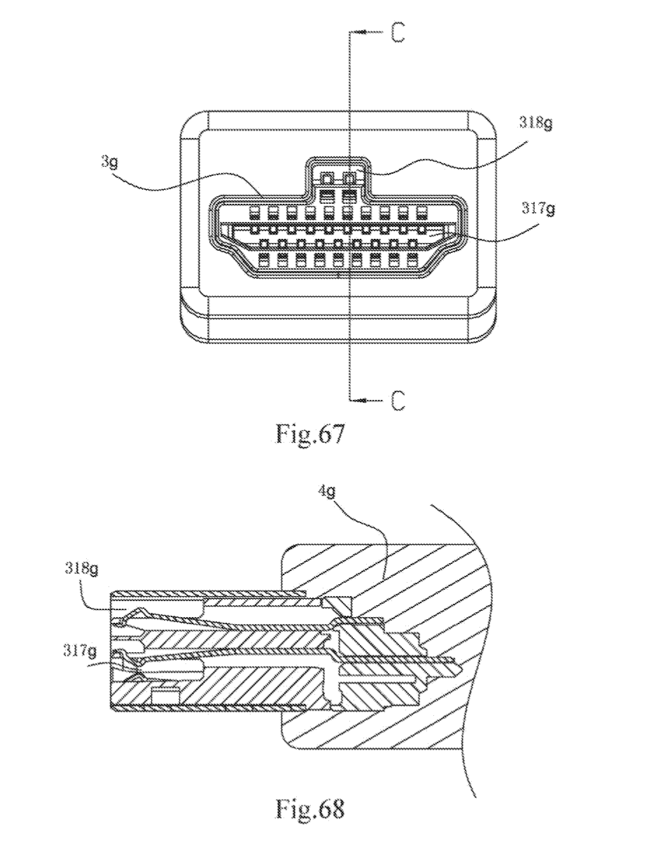

Referring to FIGS. 66-68, a third cable connector with an additional power supply is shown. The third cable connector is adapted to mate with the third receiving chamber 164g in accordance with the eighth embodiment, and satisfied with the HDMI transport protocols. The third cable connector comprises a plug electrical connector 3g (the third embodiment of the plug electrical connector), a cable 5g electrically connected with the plug electrical connector 3g, and an insulated housing 4g covering the periphery of the connection position between the plug electrical connector 3g and the cable 5g. The mating plug 3g has s third mating chamber 317g satisfied with the HDMI interface standard and a fourth mating chamber 318g. The third tongue 162g can be inserted into the third mating chamber 317g for transmitting high definition signals satisfied with the HDMI transmitting standard, and the fourth tongue 163g can be inserted into the fourth mating chamber 318g for transmitting power and satisfied with the power requirement of the display device, when the plug electrical connector 3g is mated with the receptacle electrical connector 1g of the eighth embodiment.

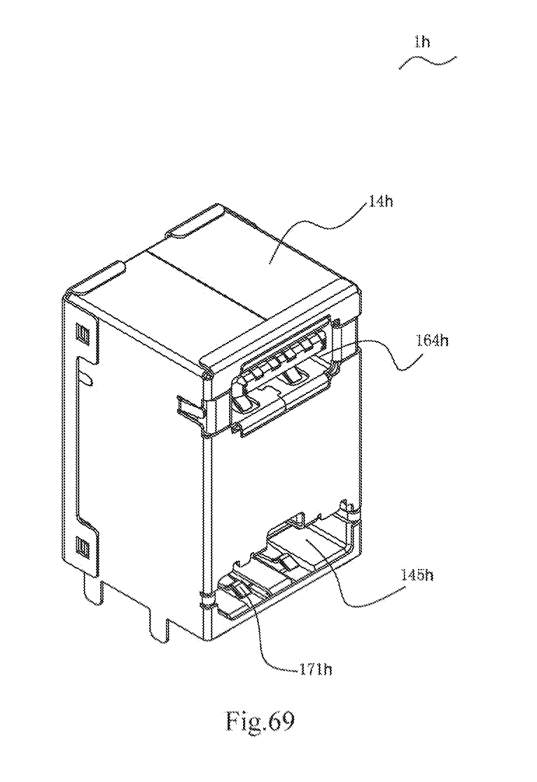

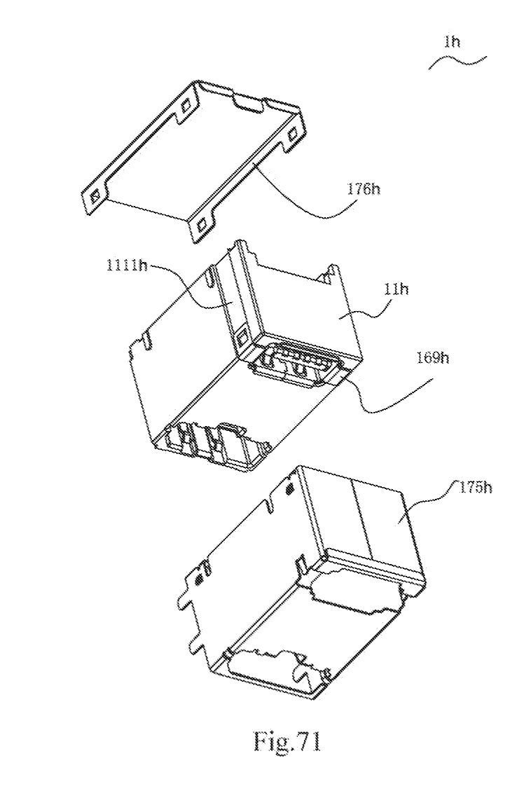

A ninth embodiment of the receptacle electrical connector 1h is shown in FIGS. 69-72 and comprises a first body 11h; a plurality of first terminals 12h, two second terminals 13h and a plurality of fifth terminals 167h mounted on the first body 11h; an elastic clasp element 171h, two holding elements 172h, an insulated fixing element 168h and a third cage 169h mounted on the first body 11h; a first cage 14h covers the first body 11h; and a first retention element 15h mounted on a bottom of the rear end of the first body 11h.

The structure of the receptacle electrical connector 1h is similar as that of the above seventh embodiment of the receptacle electrical connector except that there is a USB 3.0 receptacle opening (corresponding to the third receiving chamber 164h) on the upper of the receptacle electrical connector 1h. The HPDP receptacle opening (corresponding to the first receiving chamber 145h) on the lower of the receptacle electrical connector 1h is the same as the HPDP receptacle opening in the seventh embodiment, and the description thereof is omitted.

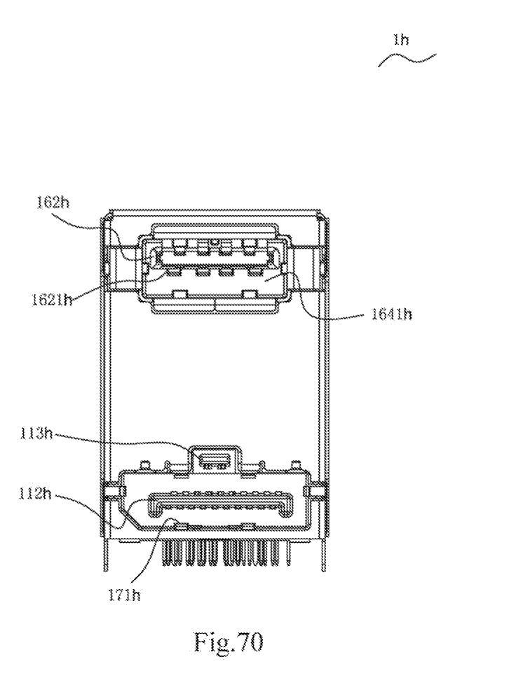

As shown in FIG. 70, the first body 11h is provided with a third receiving chamber 164h recessed therein. The third receiving chamber 164h has a rectangle shape and comprises a fifth mating chamber 1641h in which the third tongue 162h is located. A standard USB 3.0 type plug can be inserted within the fifth mating chamber 1641h. A plurality of fifth receiving slots 1621h are provided in the third tongue 162h which can be mated with a standard USB 3.0 plug electrical connector.

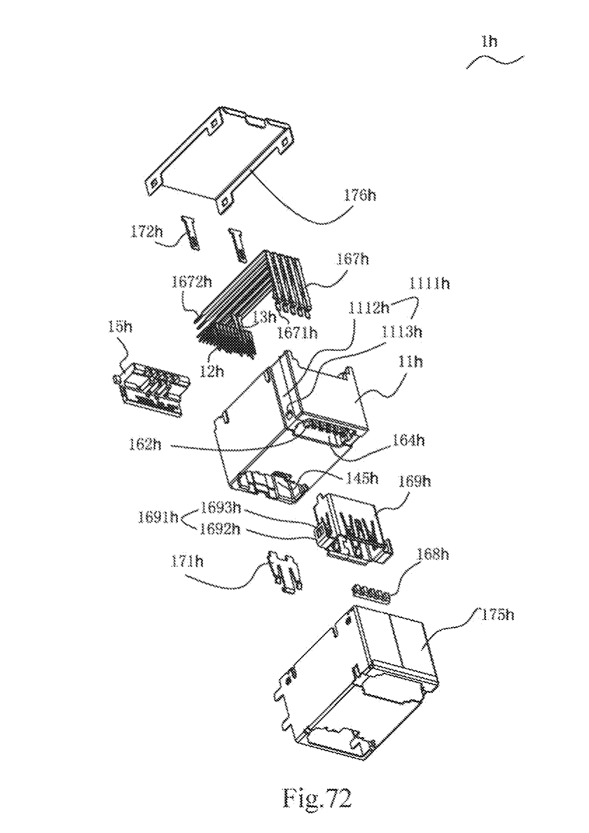

As shown in FIG. 72, the first body 11h is formed with a clasp portion 1111h on sides near the third receiving chamber 164h. In details, each of the clasp portions 1111h comprises a groove 1112h formed on two sides of the first body 11h and a clasping block 1113h protruded from the groove 1112h.

Each of the fifth terminals 167h comprises a mating portion 1671h and a soldering portion 1672h. The mating portions 1671h of the fifth terminals 167h are provided in the fifth receiving slots 1621h of the third tongue 162h. An insulated fixing element 168h is mounted on a front end of the third tongue 163h to realize the separation between the front and rear rows of fifth terminals 167h.

The third cage 169h is mounted in the third receiving chamber 164h, and has two buckle portions 1691h bending outwardly and then bending backwardly from two sides thereof respectively. In details, the buckle portions 1691h comprise a buckling arm 1692h bending outwardly and backwardly from the sides thereof, and a buckling hole 1693h provided in the buckling arm 1692h. The buckling arm 1692h is corresponding to the grooves 112h in the clasp portions 1111h of the first body 11h, and the buckling hole 1693h is mated with the clasping block 1113h, when the third cage 169h is inserted into the third receiving chamber 164h.

The assembly procedure of the receptacle electrical connector 1h is as follows: inserting the first terminals 12h, the second terminals 13h and the fifth terminals 167h into the first body 11h in a direction of from rear to front, and mounting the insulated fixing element 168h in the front end of the third tongue 162h; and mounting the third cage 169h into the third receiving chamber 164h in a direction of from front to rear; aligning the first retention element 15h with the soldering portions of those terminals and inserting the first retention element 15h in a direction of from lower to upper; inserting the two holding portions 172h into the first body 11h in a direction of from rear to front, and then inserting the two elastic elements 171h into the first body 11h in a direction of from front to rear; and finally mounting the front shielding element 175h and the rear shielding element 176h into the first body 11h.

As compared with the conventional connector, the receptacle electrical connectors 1f, 1g, 1 h in accordance with the seventh, eighth and ninth embodiments have the following advantageous effects in addition to the effects in the first embodiment: the first receiving chambers 145f, 145g, 145h are recessed from the first insulated bodies 11f, 11g, 11h, and thusly the receiving chambers formed as above have a improved strength, are not easily broken and deformed. In addition, the third receiving chambers 164f, 164g, 164h are recessed from the first insulated bodies 11f, 11g, 11 h, and thusly two identical or different receptacle openings of the electrical connector can be combined together, so as to increase the function of the connector.

While preferred embodiments of the present application, not for limiting the present invention, are shown and described, it is envisioned that those skilled in the art may easily devise various modifications in accordance with the spirit and scope of the foregoing Description and the appended Claims.

What is claimed is:

1. A connector, comprising:
a first body that includes a first main body portion, a first tongue and a second tongue, the first and second tongues being parallel with each other and extending forward from the first main body portion, wherein the first tongue has a first surface and a second surface opposite the first surface and a first width and the second tongue has a third surface and a second width that is less than the first width, the first tongue including a plurality of first receiving slots provided on the first and second surfaces and a plurality of second receiving slots provided on the third surface;
a plurality of first terminals provided in the first receiving slots, each first terminals being provided with a mating portion in a plate shape and a soldering portion, the mating portions of the first terminals located on a first surface being offset relative to the mating portions on a second surface;
at least two second terminals for transmitting power provided in the plurality of second receiving slots, each second terminals being provided with a mating portion in a plate shape and a soldering portion; and
a cage mounted on the first body that forms a first mating chamber and a second mating chamber, the first mating chamber formed around and enclosing the first tongue and having a third width, the second mating chamber formed around and enclosing the second tongue and having a fourth width that is less than the third width, wherein the first and second mating chambers are in communication with each other.

2. The connector according to claim 1, wherein the first tongue comprises a base with a plate shape and two keying ribs protruding away from two sides of the base.

3. The connector according to claim 1, wherein two of the plurality of second terminals are configured to be connected to a negative power input and positive power input and wherein an end of the mating portion of the second terminal for connecting with the negative power input is located at a position closer to a front than an end of the mating portion of the second terminal for connecting with the positive power input.

4. The connector according to claim 1, wherein each of the second terminals comprises a fixing portion provided between the mating portion and the soldering portion, the soldering portions of the plurality of second terminals are bent and extended away from each other and from ends of the fixing portions such that a distance between the soldering portions is greater than a distance between the mating portions.

5. The connector according to claim 1, wherein the cage encloses the first tongue and the second tongue so as to form a first receiving chamber.

6. The connector according to claim 5, wherein the cage is configured to have an arching portion that forms the second mating chamber and a hole is provided on both sides of the arching portion.

7. The connector according to claim 5, wherein the connector further comprises a first retention element fixed on the first body, the first retention element being provided with a plurality of perforations through which the soldering portions of the plurality of the first terminals and at least two second terminals are inserted.

8. The connector according to claim 5, wherein a clasp portion is provided on the cage, the connector further comprising a first retention element which is provided with a holding portion corresponding to the clasp portion such that the first retention element is fixed in the cage and abutted against the rear end of the first main body portion.

9. The connector according to claim 8, wherein the first retention element includes a base on which a plurality of first perforations for inserting the soldering portion of the first terminals are provided, and further includes a protrusion extending upward from the base, the protrusion including at least two second perforations for inserting the soldering portion of at least two second terminals are provided, each of upper and lower surfaces of the base including two holding portion.

10. The connector according to claim 9, wherein the protrusion comprises a vertical wall extending upward from the rear end of the upper surface of the base, a top plate extending forward from the top end of the vertical wall, and a partition plate extending downward from the bottom of the top plate, and at least one said second perforation is provided at each of the two sides of the partition plate on the vertical wall.

11. The connector according to claim 8, wherein the first cage comprises a top plate, two opposite side plates and a bottom plate and each of the top plate and the bottom plate are provided with two clasp portions.

12. The connector according to claim 8, wherein the cage is configured to have an arching portion for forming the second mating chamber and a hole is provided on the left and right side of the arching portion respectively and one of the clasp portions is provided at each side of the arching portion.

13-47. (canceled)
